(19) United States
(12) Patent Application Publication
(10) Pub. No.: US 2023/0004787 A1
(43) Pub. Date: Jan. 5, 2023

(54) Distributed Deep Learning System

(71) Applicant: Nippon Telegraph and Telephone Corporation, Tokyo (JP)

(72) Inventors: Kenji Tanaka, Tokyo (JP); Yuki Arikawa, Tokyo (JP); Tsuyoshi Ito, Tokyo (JP); Kazuhiko Terada, Tokyo (JP); Takeshi Sakamoto, Tokyo (JP)

(21) Appl. No.: 17/779,736

(22) PCT Filed: Nov. 27, 2019
(86) PCT No.: PCT/JP2019/046373

§ 371 Date: May 25, 2022

(51) Int. Cl. G06N 3/063; G06N 3/08

(52) U.S. Cl. CPC G06N 3/063; G06N 3/08

(57) ABSTRACT

A distributed deep learning system includes nodes (1-n, n=1, . . . , 4) and a network. The node (1-n) includes GPUs (11-n-1 and 11-n-2), and an FPGA (12-n). The FPGA (12-n) includes a plurality of GPU reception buffers, a plurality of network transmission buffers that store data transferred from the GPU reception buffers, a plurality of network reception buffers that store aggregated data received from other nodes, and a plurality of GPU transmission buffers that store data transferred from the network reception buffers. The GPUs (11-n-1 and 11-n-2) DMA-transfer data to the FPGA (12-n). The data stored in the GPU transmission buffers is DMA-transferred to the GPUs (11-n-1 and 11-n-2).

### CROSS-REFERENCE TO RELATED APPLICATIONS

This application is a national phase entry of PCT Application No. PCT/JP2019/046373, filed on Nov. 27, 2019, which application is hereby incorporated herein by reference.

### TECHNICAL FIELD

The present invention relates to a distributed deep learning system that executes deep learning, which is machine learning using a neural network, by using a plurality of nodes in a distributed and collaborative manner.

### BACKGROUND

Deep learning is to learn models adapted to input data by alternately performing forward propagation and back propagation. In recent years, accelerators such as a graphics processing unit (GPU) are used to efficiently perform the forward propagation and the back propagation. In recent years, there exist enormous amounts of input data, processing of which by one computing device causes storage and I/O (input/output) bottlenecks to occur, and thus, data parallel distributed deep learning has been proposed in which data is distributed and processed in a plurality of computing devices (see NPL 1).

In the data parallel distributed deep learning, computing devices performs forward propagations and back propagations different from each other, and resulting weight data after the back propagations is shared using communications. This sharing is a collective communication process called Allreduce. In Allreduce, the weight data calculated by each computing device is reduced (summed) and broadcast (distributed). It is known that Allreduce has an important role in the data parallel distributed deep learning but is a bottleneck.

FIG. 28 is a block diagram illustrating a configuration of a distributed deep learning system of related art. The distributed deep learning system includes N nodes 100-n (n=1, . . . , N) and a network 200 connecting the N nodes 100-n to each other (where N is an integer of 2 or more, and here N=4).

A master node 100-1 includes a central processing unit (CPU) 101-1, a GPU 102-1, and an FPGA 103-1.

A slave node 100-k (k=2, . . . , N) includes a CPU 101-k, a GPU 102-k-1, and an FPGA 103-k.

FIG. 29 is a functional block diagram of the FPGA 103-1 of the master node 100-1. The FPGA 103-1 functions as a GPU reception buffer 120, a GPU transmission buffer 121, network transmission buffers 122 and 123, network reception buffers 124 and 125, a transmission unit 126, a transmission unit 128, and a reception unit 129.

FIG. 30 is a functional block diagram of the FPGA 103-k of the slave node 100-k (k=2, . . . , N). The FPGA 103-k functions as the GPU reception buffer 120, the GPU transmission buffer 121, the network transmission buffers 122 and 123, the network reception buffers 124 and 125, a transmission unit 126, a reception unit 127, the transmission unit 128, and the reception unit 129.

Hereinafter, an Allreduce process will be described. The GPU 102-n of each node 100-n calculates gradients for weights of a model to be learned, and calculates distributed data D by totaling the gradients for each weight. The GPU 102-n of each node 100-n direct memory access (DMA)-transfers the distributed data D to the GPU reception buffer 120 in the FPGA 103-n of the node 100-n. Data stored in the GPU reception buffer 120 is transferred to either the network transmission buffer 122 or 123 having an available space.

In the FPGA 103-n of each node 100-n, in a case that the data is stored in the network transmission buffer 122 or 123, and either the network reception buffer 124 or 125 of the FPGA 103-n is empty, a check flag is set.

In a case that the check flag is set in every node 100-n including the master node 100-1, the transmission unit 126 in the FPGA 103-1 of the master node 100-1 retrieves the distributed data D stored in the network transmission buffer 122 or 123 in the FPGA 103-1, and transmits the retrieved data as intermediate aggregated data Rt[i] to the next numbered node 100-2 via a communication path 201.

The reception unit 127 in the FPGA 103-k of the slave node 100-k (k=2, . . . , N) receives the intermediate aggregated data Rt[k−1] from the node 100-(k−1) via the communication path 201.

An addition unit 131 in the FPGA 103-k of the slave node 100-k retrieves the distributed data D stored in the network transmission buffer 122 or 123 in the FPGA 103-k. Then, the addition unit 131 calculates a sum of the retrieved distributed data D and the intermediate aggregated data Rt[k−1] received from the communication path 201 to generate the intermediate aggregated data Rt[k].

The transmission unit 126 in the FPGA 103-k of the slave node 100-k transmits the intermediate aggregated data Rt[k] generated by the addition unit 131 in the FPGA 103-k to the next numbered node 100-k⁺ (k⁺=k+1, where k⁺=1 in a case of k=N) via the communication path 201.

The reception unit 129 in the FPGA 103-1 of the master node 100-1 receives the intermediate aggregated data Rt[N] from the node 100-N via the communication path 201.

The transmission unit 128 in the FPGA 103-1 of the master node 100-1 transmits the received intermediate aggregated data Rt[N] as aggregated data R to the next numbered node 100-2 via the communication path 201.

The reception unit 129 in the FPGA 103-1 of the master node 100-1 transfers the aggregated data R received from the node 100-N via the communication path 201 to either the network reception buffer 124 or 125 having an available space in the FPGA 103-1. The data stored in the network reception buffer 124 or 125 is transferred to the GPU transmission buffer 121 in the FPGA 103-1. The data stored in the GPU transmission buffer 121 is DMA-transferred to the GPU 102-1.

The reception unit 129 in the FPGA 103-k of the slave node 100-k (k=2, . . . , N) receives the aggregated data R from the node 100-(k−1) via the communication path 201.

The transmission unit 128 in the FPGA 103-k of the slave node 100-k transmits the received aggregated data R to the next numbered node 100-k⁺ (k⁺=n+1, where n+=1 in a case of k=N) via the communication path 201.

The reception unit 129 in the FPGA 103-k of the slave node 100-k transfers the aggregated data R received from the node 100-(k−1) via the communication path 201 to either the network reception buffer 124 or 125 having an available space in the FPGA 103-k. The data stored in the network reception buffer 124 or 125 is transferred to the GPU transmission buffer 121 in the FPGA 103-k. The data stored in the GPU transmission buffer 121 is DMA-transferred to the GPU 102-k.

In the above Allreduce process, a file descriptor in the DMA transfer needs to be specified in a one-to-one manner. For this reason, in the distributed deep learning system of related art illustrated in FIG. 28, the file descriptors needs to be specified with times being shifted for performing the DMA transfer in order to perform the Allreduce process by a plurality of GPUs using the FPGAs, leading to a problem of large communication overhead.

### CITATION LIST

### Non Patent Literature

NPL 1: Kenji Tanaka, et al., “Research Poster: (RP04) Distributed Deep Learning with FPGA Ring Allreduce”, ISC 2019, 2019, https://2019.isc-program.com/presentation/?id=post120&sess=sess182.

### SUMMARY

### Technical Problem

Embodiments of the present invention are made to solve the above problem and has an object to provide a distributed deep learning system capable of reducing overhead of Allreduce process.

### Means for Solving the Problem

A distributed deep learning system according to embodiments of the present invention (first to fifth embodiments) includes a plurality of nodes connected with each other via a network, wherein each node of the nodes including a plurality of GPUs configured to generate distributed data per weight of a model to be learned, a plurality of first reception buffers configured to store the distributed data from the GPUs, a plurality of first transmission buffers configured to store the distributed data transferred from the first reception buffers, a plurality of second reception buffers configured to store aggregated data received from another node, a second transmission buffer configured to store the aggregated data transferred from any of the second reception buffers, a monitoring unit configured to set a check flag when data is stored in any of the first transmission buffers and any of the second reception buffers has an available space, a first transmission unit configured to transmit, when the check flag is set in the node itself and every other node in a case that the node functions as the first numbered node among the plurality of nodes, the distributed data stored in any of the first transmission buffers as first aggregated data to the next numbered node, and transmit, in a case that the node functions as a node except for the first numbered node among the plurality of nodes, updated first aggregated data to the next numbered node, a first reception unit configured to receive, in the case that the node functions as the node except for the first numbered node among the plurality of nodes, the first aggregated data from another node, an addition unit configured to calculate, in the case that the node functions as the node except for the first numbered node among the plurality of nodes, a sum of the distributed data stored in the first transmission buffer and the first aggregated data received by the first reception unit per weight to generate the updated first aggregated data, a second reception unit configured to receive the updated first aggregated data in the case that the node functions as the first numbered node among the plurality of nodes, and receives second aggregated data in the case that the node functions as the node except for the first numbered node among the plurality of nodes, a second transmission unit configured to transmit, in the case that the node functions as the first numbered node among the plurality of nodes, the first aggregated data received by the second reception unit as the second aggregated data to the next numbered node, and transmit, in the case that the node functions as the node except for the first numbered node among the plurality of nodes, the second aggregated data received by the second reception unit to the next numbered node, a first transfer unit configured to transfer the distributed data stored in the first reception buffers to the first transmission buffers, and DMA-transfer the aggregated data stored in the second transmission buffer to the plurality of GPUs, and a second transfer unit configured to transfer the aggregated data stored in the second reception buffers to the second transmission buffer, and the plurality of GPUs DMA-transfer the distributed data to the plurality of first reception buffers.

In an exemplary configuration of the distributed deep learning system according to embodiments of the present invention (second embodiment), a plurality of communication paths are configured in the network, each node includes the plurality of GPUs, the first reception buffers the number of which is the same as the number of the communication paths, the plurality of first transmission buffers provided per one communication path, the plurality of second reception buffers provided per one communication path, the second transmission buffers the number of which is the same as the number of the communication paths, the monitoring unit, the first and second transmission units, the first and second reception units, the addition unit, the first transfer unit, and the second transfer unit, each of the GPUs includes a third transmission unit configured to DMA-transfer the distributed data to respective corresponding first reception buffers, a third reception unit configured to receive the second aggregated data DMA-transferred by the first transfer unit, a fourth transmission unit configured to transmit the second aggregated data received by the third reception unit to another GPU, a fourth reception unit configured to receive the second aggregated data transmitted from another GPU, an aggregation processing unit configured to calculate a sum of the second aggregated data received by the third reception unit and the second aggregated data received by the fourth reception unit per weight to generated third aggregated data, and an updating unit configured to update the model in accordance with the third aggregated data, the first transfer unit transfers the distributed data stored in the first reception buffer corresponding to one communication path to the first transmission buffer corresponding to the communication path, and DMA-transfers the second aggregated data stored in the second transmission buffer corresponding to one communication path to the GPU corresponding to the communication path, the second transfer unit transfers the second aggregated data stored in the second reception buffer corresponding to one communication path to the second transmission buffer corresponding to the communication path, when the data is stored in the first transmission buffer and the second reception buffer has an available space, the first transmission buffer and the second reception buffer corresponding to the identical communication path, the monitoring unit sets the check flag corresponding to the communication path, in the case that the node functions as the first numbered node among the plurality of nodes when the check flag corresponding to the identical communication path is set in the node itself and every other node, and the check flag corresponding to another communication path is not set in at least one node, the first transmission unit transmits the distributed data stored in the first transmission buffer corresponding to the identical communication path as the first aggregated data to the next numbered node via the identical communication path, and the addition unit calculates a sum of the distributed data stored in the first transmission buffer corresponding to one communication path and the first aggregated data received from the communication path by the first reception unit per weight to generate the updated first aggregated data.

In an exemplary configuration of the distributed deep learning system according to embodiments of the present invention (third embodiment), a plurality of communication paths are configured in the network, each node includes the plurality of GPUs, the first reception buffers the number of which is the same as the number of the communication paths, the plurality of first transmission buffers provided per one communication path, the plurality of second reception buffers provided per one communication path, the second transmission buffers the number of which is the same as the number of the communication paths, the monitoring unit, the first and second transmission units, the first and second reception units, the addition unit, the first transfer unit, and the second transfer unit, each of the GPUs includes a third transmission unit configured to DMA-transfer the distributed data to any of the plurality of first reception buffers, a third reception unit configured to receive the second aggregated data DMA-transferred by the first transfer unit, a fourth transmission unit configured to transmit the second aggregated data received by the third reception unit to another GPU, a fourth reception unit configured to receive the second aggregated data transmitted from another GPU, an aggregation processing unit configured to calculate a sum of the second aggregated data received by the third reception unit and the second aggregated data received by the fourth reception unit per weight to generated third aggregated data, and an updating unit configured to update the model in accordance with the third aggregated data, the first transfer unit transfers the distributed data stored in the first reception buffer corresponding to one communication path to the first transmission buffer corresponding to the communication path, and DMA-transfers the second aggregated data stored in the second transmission buffer corresponding to one communication path to the GPU corresponding to the second aggregated data, the second transfer unit transfers the second aggregated data stored in the second reception buffer corresponding to one communication path to the second transmission buffer corresponding to the communication path, when the data is stored in the first transmission buffer and the second reception buffer has an available space, the first transmission buffer and the second reception buffer corresponding to the identical communication path, the monitoring unit sets the check flag corresponding to the communication path, in the case that the node functions as the first numbered node among the plurality of nodes when the check flag corresponding to the identical communication path is set in the node itself and every other node, and the check flag corresponding to another communication path is not set in at least one node, the first transmission unit transmits the distributed data stored in the first transmission buffer corresponding to the identical communication path as the first aggregated data to the next numbered node via the identical communication path, and in a case that the GPU deriving the first aggregated data received from another node by the first reception unit is in the same combination with the GPU generating the distributed data and the distributed data is stored in the first transmission buffer, the addition unit calculates a sum of the distributed data and the first aggregated data received by the first reception unit per weight to generate the updated first aggregated data.

In an exemplary configuration of the distributed deep learning system according to embodiments of the present invention (fourth embodiment), a plurality of communication paths are configured in the network, each node includes the plurality of GPUs, the first reception buffers the number of which is the same as the number of the communication paths, the plurality of first transmission buffers provided per one communication path, the plurality of second reception buffers provided per one communication path, the second transmission buffers the number of which is the same as the number of the communication paths, the monitoring unit, the first and second transmission units, the first and second reception units, the addition unit, the first transfer unit, and the second transfer unit, each of the GPUs includes a third transmission unit configured to DMA-transfer the distributed data to the first reception buffer not busy among the plurality of reception buffers, a third reception unit configured to receive the second aggregated data DMA-transferred by the first transfer unit, and an updating unit configured to update the model in accordance with the second aggregated data received by the third reception unit, the first transfer unit transfers the distributed data stored in the first reception buffer corresponding to one communication path to the first transmission buffer corresponding to the communication path, and DMA-transfers the second aggregated data stored in the second transmission buffer corresponding to one communication path to the GPU corresponding to the communication path, the second transfer unit transfers the second aggregated data stored in the second reception buffer corresponding to one communication path to the second transmission buffer corresponding to the communication path, when the data is stored in the first transmission buffer and the second reception buffer has an available space, the first transmission buffer and the second reception buffer corresponding to the identical communication path, the monitoring unit sets the check flag corresponding to the communication path, in the case that the node functions as the first numbered node among the plurality of nodes when all check flags are set in the node itself and every other node, the first transmission unit transmits the distributed data stored in the plurality of first transmission buffers as the first aggregated data to the next numbered node via the communication paths corresponding to the first transmission buffers storing the distributed data, and the addition unit calculates a sum of the distributed data stored in the plurality of first transmission buffers corresponding to the plurality of communication paths and the first aggregated data received from the plurality of communication paths by the first reception unit per weight to generate the updated first aggregated data.

In an exemplary configuration of the distributed deep learning system according to embodiments of the present invention (fifth embodiment), a plurality of communication paths are configured in the network, each node includes the plurality of GPUs, the first reception buffers the number of which is the same as the number of the communication paths, the plurality of first transmission buffers provided per one communication path, the plurality of second reception buffers provided common to the plurality of communication paths, the second transmission buffer provided common to the plurality of communication paths, the monitoring unit, the first and second transmission units, the first and second reception units, the addition unit, the first transfer unit, and the second transfer unit, each of the GPUs includes a third transmission unit configured to DMA-transfer the distributed data to the first reception buffer not busy among the plurality of reception buffers, a third reception unit configured to receive the second aggregated data DMA-transferred by the first transfer unit, and an updating unit configured to update the model in accordance with the second aggregated data received by the third reception unit, the first transfer unit transfers the distributed data stored in the first reception buffer corresponding to one communication path to the first transmission buffer corresponding to the communication path, and DMA-transfers the second aggregated data stored in the second transmission buffer to the plurality of GPUs, the second transfer unit transfers the second aggregated data stored in any of the plurality of second reception buffers to the second transmission buffer, when the data is stored in the first transmission buffer and the second reception buffer has an available space, the first transmission buffer and the second reception buffer corresponding to the identical communication path, the monitoring unit sets the check flag corresponding to the communication path, in the case that the node functions as the first numbered node among the plurality of nodes when all check flags are set in the node itself and every other node, the first transmission unit transmits the distributed data stored in the plurality of first transmission buffers as the first aggregated data to the next numbered node via the communication paths corresponding to the first transmission buffers storing the distributed data, and the addition unit calculates a sum of the distributed data stored in the plurality of first transmission buffers corresponding to the plurality of communication paths and the first aggregated data received from the plurality of communication paths by the first reception unit per weight to generate the updated first aggregated data.

A distributed deep learning system according to embodiments of the present invention (sixth embodiment) includes a plurality of nodes connected with each other via a network, each of the nodes includes a plurality of GPUs configured to generate distributed data per weight of a model to be learned, a plurality of first reception buffers configured to store the distributed data from the GPUs, a first addition unit configured to calculate a sum of a plurality of pieces of the distributed data transferred from the plurality of first reception buffers per weight to generate a first aggregated data, a plurality of first transmission buffers configured to store the first aggregated data, a plurality of second reception buffers configured to store aggregated data received from another node, a second transmission buffer configured to store the aggregated data transferred from any of the second reception buffers, a monitoring unit configured to set a check flag when data is stored in any of the first transmission buffers and any of the second reception buffers has an available space, a first transmission unit configured to transmit, when the check flag is set in the node itself and every other node in a case that the node functions as the first numbered node among the plurality of nodes, the first aggregated data stored in any of the first transmission buffers as second aggregated data to the next numbered node, and transmit, in a case that the node functions as a node except for the first numbered node among the plurality of nodes, updated second aggregated data to the next numbered node, a first reception unit configured to receive, in the case that the node functions as the node except for the first numbered node among the plurality of nodes, the second aggregated data from another node, a second addition unit configured to calculate, in the case that the node functions as the node except for the first numbered node among the plurality of nodes, a sum of the first aggregated data stored in the first transmission buffer and the second aggregated data received by the first reception unit per weight to generate the updated first aggregated data, a second reception unit configured to receive the updated second aggregated data in the case that the node functions as the first numbered node among the plurality of nodes, and receives third aggregated data in the case that the node functions as the node except for the first numbered node among the plurality of nodes, a second transmission unit configured to transmit, in the case that the node functions as the first numbered node among the plurality of nodes, the second aggregated data received by the second reception unit as the third aggregated data to the next numbered node, and transmit, in the case that the node functions as the node except for the first numbered node among the plurality of nodes, the third aggregated data received by the second reception unit to the next numbered node, a first transfer unit configured to transfer the distributed data stored in the first reception buffers to the first addition unit, and DMA-transfer the third aggregated data stored in the second transmission buffer to the plurality of GPUs, and a second transfer unit configured to transfer the third aggregated data stored in the second reception buffers to the second transmission buffer, wherein the plurality of GPUs DMA-transfer the distributed data to the plurality of first reception buffers, and updates the model in accordance with the third aggregated data.

In an exemplary configuration of the distributed deep learning system according to embodiments of the present invention (sixth embodiment), one communication path is configured in the network, each node includes the plurality of GPUs, the first reception buffers the number of which is the same as the number of the GPUs, the plurality of first reception buffers, the plurality of second reception buffers, the second transmission buffers the number of which is the same as the number of the communication path, the monitoring unit, the first and second transmission units, the first and second reception units, the addition unit, the first transfer unit, and the second transfer unit, each of the GPUs includes a third transmission unit configured to DMA-transfer the distributed data to the first reception buffer not busy among the plurality of reception buffers, a third reception unit configured to receive the third aggregated data DMA-transferred by the first transfer unit, and an updating unit configured to update the model in accordance with the third aggregated data received by the third reception unit, the second transfer unit transfers the third aggregated data stored in any of the plurality of second reception buffers to the second transmission buffer, when the data is stored in the first transmission buffer and the second reception buffer has an available space, the first transmission buffer and the second reception buffer corresponding to the identical communication path, the monitoring unit sets the check flag corresponding to the communication path, and the second addition unit calculates a sum of the first aggregated data stored in any of the plurality of first transmission buffers and the second aggregated data received from the communication path by the first reception unit per weight to generate the updated second aggregated data.

### Effects of Embodiments of the Invention

According to embodiments of the present invention, a DMA wait time is reduced in each GPU of each node, and thus, each GPU can perform other processing by a reduced DMA wait time. In embodiments of the present invention, a band of the network can be effectively used by increasing a first transmission buffer than in the current system. As a result, embodiments of the present invention can reduce overhead of the Allreduce process.

### BRIEF DESCRIPTION OF THE DRAWINGS

FIG. 1 is a block diagram illustrating a configuration of a distributed deep learning system according to a first embodiment of the present invention.

FIG. 2 is a functional block diagram of a GPU according to the first embodiment of the present invention.

FIG. 3 is a functional block diagram of an FPGA of a master node according to the first embodiment of the present invention.

FIG. 4 is a functional block diagram of an FPGA of a slave node according to the first embodiment of the present invention.

FIG. 5 is a flowchart illustrating a sample data input process, a gradient calculation process, and an intra-GPU aggregation process of each GPU of the node according to the first embodiment of the present invention.

FIG. 6 is a flowchart illustrating an inter-node Allreduce process for the master node according to the first embodiment of the present invention.

FIG. 7 is a flowchart illustrating an inter-node Allreduce process for the slave node according to the first embodiment of the present invention.

FIG. 8 is a flowchart illustrating an inter-GPU Allreduce process and a weight updating process in each node according to the first embodiment of the present invention.

FIG. 9 is a flowchart illustrating an inter-GPU Allreduce process in each node according to the first embodiment of the present invention.

FIG. 10 is a block diagram illustrating a configuration of a distributed deep learning system according to a third embodiment of the present invention.

FIG. 11 is a functional block diagram of a GPU according to the third embodiment of the present invention.

FIG. 12 is a functional block diagram of an FPGA of a master node according to the third embodiment of the present invention.

FIG. 13 is a functional block diagram of an FPGA of a slave node according to the third embodiment of the present invention.

FIG. 14 is a block diagram illustrating a configuration of a distributed deep learning system according to a fourth embodiment of the present invention.

FIG. 15 is a functional block diagram of a GPU according to the fourth embodiment of the present invention.

FIG. 16 is a functional block diagram of an FPGA of a master node according to the fourth embodiment of the present invention.

FIG. 17 is a functional block diagram of an FPGA of a slave node according to the fourth embodiment of the present invention.

FIG. 18 is a flowchart illustrating a weight updating process in a node according to the fourth embodiment of the present invention.

FIG. 19 is a block diagram illustrating a configuration of a distributed deep learning system according to a fifth embodiment of the present invention.

FIG. 20 is a functional block diagram of an FPGA of a master node according to the fifth embodiment of the present invention.

FIG. 21 is a functional block diagram of an FPGA of a slave node according to the fifth embodiment of the present invention.

FIG. 22 is a block diagram illustrating a configuration of a distributed deep learning system according to a sixth embodiment of the present invention.

FIG. 23 is a functional block diagram of an FPGA of a master node according to the sixth embodiment of the present invention.

FIG. 24 is a functional block diagram of an FPGA of a slave node according to the sixth embodiment of the present invention.

FIG. 25 is a flowchart illustrating an inter-node Allreduce process for the master node according to the sixth embodiment of the present invention.

FIG. 26 is a flowchart illustrating an inter-node Allreduce process for the slave node according to the sixth embodiment of the present invention.

FIG. 27 is a block diagram illustrating an exemplary configuration of a computer that implements the nodes according to the first to sixth embodiments of the present invention.

FIG. 28 is a block diagram illustrating a configuration of a distributed deep learning system of related art.

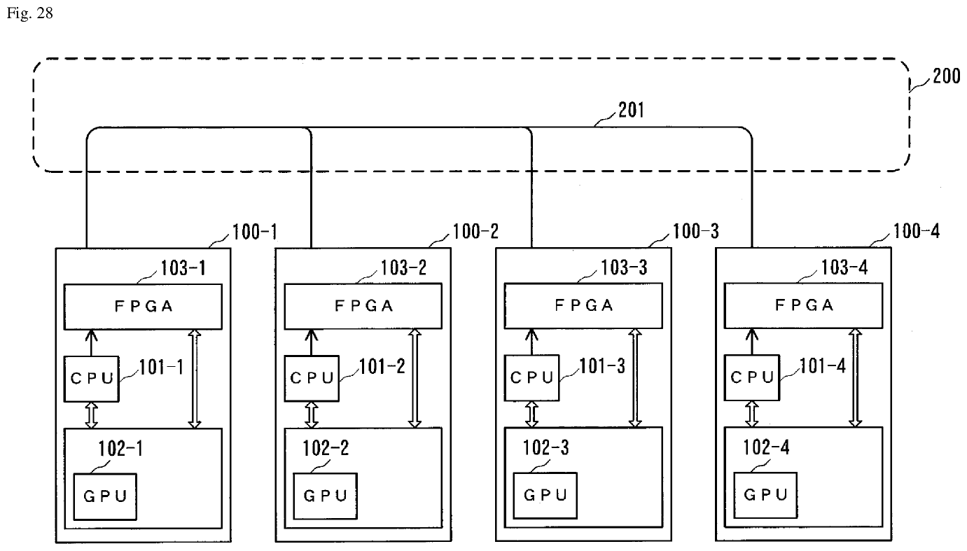

FIG. 29 is a functional block diagram of an FPGA of a master node of the distributed deep learning system of related art.

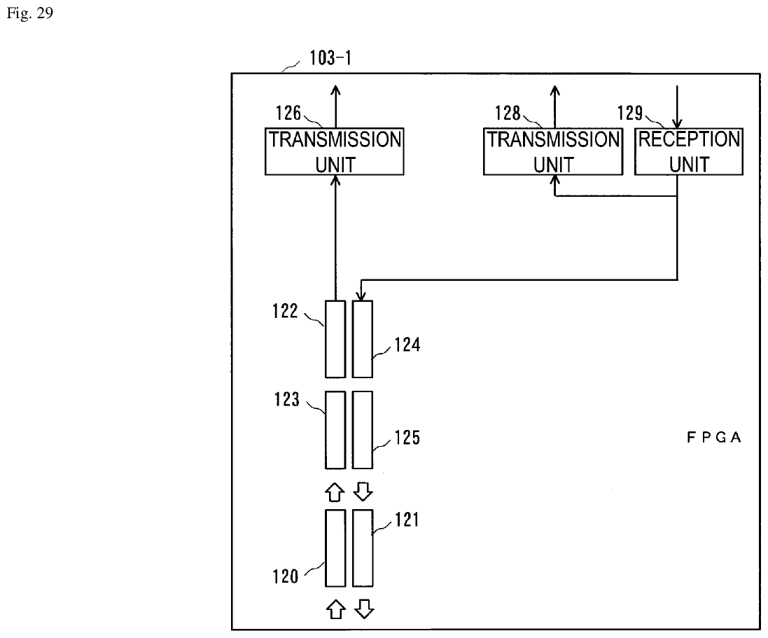

FIG. 30 is a functional block diagram of an FPGA of a slave node of the distributed deep learning system of related art.

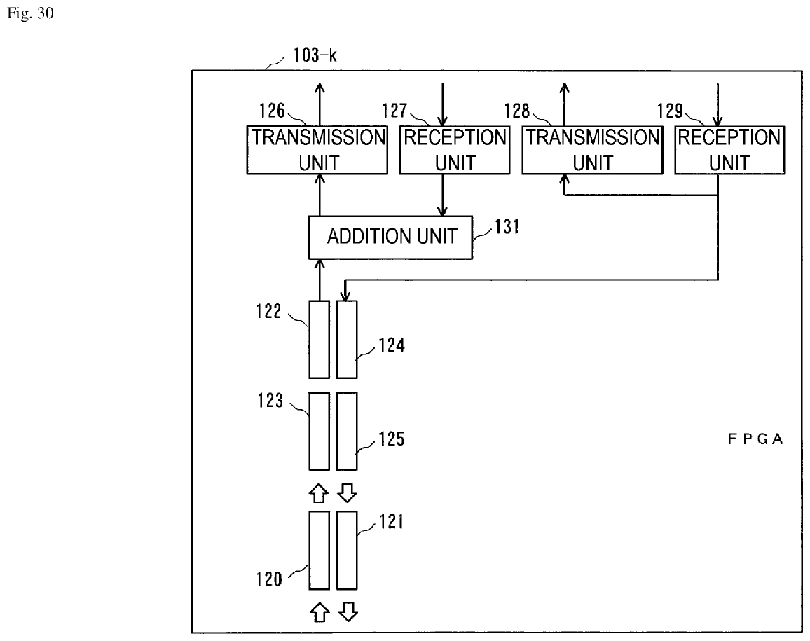

### DETAILED DESCRIPTION OF EMBODIMENTS

### First Embodiment

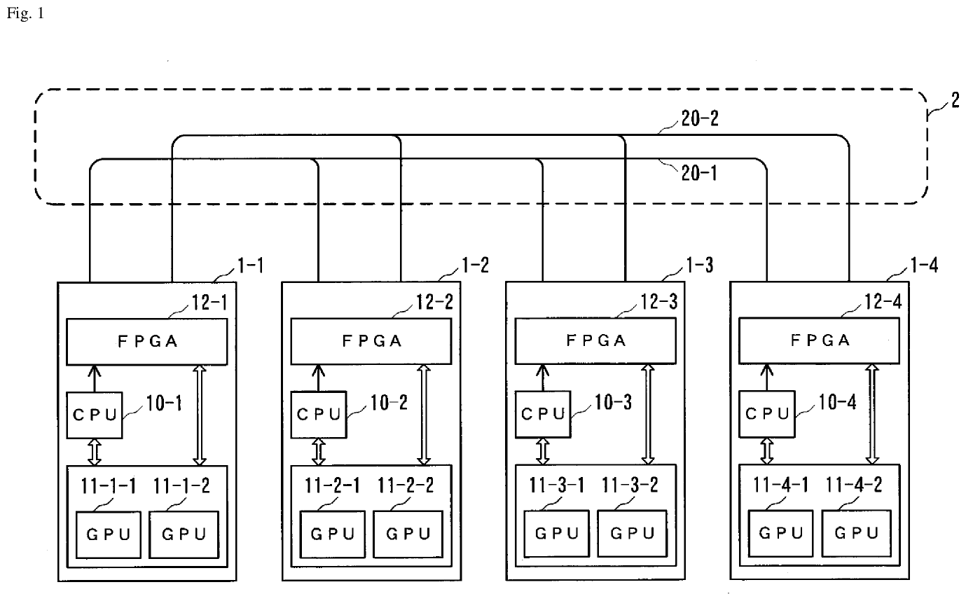

Hereinafter, embodiments of the present invention will be described with reference to the drawings. FIG. 1 is a block diagram illustrating a configuration of a distributed deep learning system according to a first embodiment of the present invention. The distributed deep learning system includes N nodes 1-n (n=1, . . . , N) and a network 2 connecting the N nodes 1-n to each other (where N is an integer of 2 or more, and N=4 in the present embodiment).

In the present embodiment, the node 1-1 is a master node and the nodes 1-2 to 1-4 are slave nodes. Two communication paths 20-1 and 20-2 are configured in the network 2. Note that, in embodiments of the present invention, a “node” refers to a device such as a server distributively disposed on a network.

The master node 1-1 includes a CPU 10-1, GPUs 11-1-1 and 11-1-2, and an FPGA 12-2.

The slave node 1-k (k=2, . . . , N) includes a CPU 10-k, GPUs 11-k-1 and 11-k−2, and an FPGA 12-k.

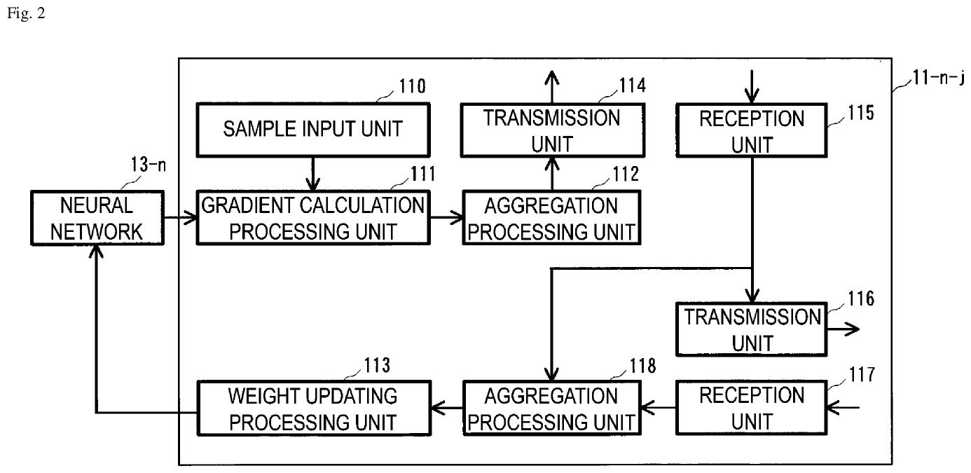

In the present embodiment, each node is provided with J GPUs (where J is an integer of 2 or more, and J=2 in the present embodiment). FIG. 2 is a functional block diagram of the GPU 11-n-j (n=1, . . . , N, j=1, . . . , J). The GPU 11-n-j functions as a sample input unit 110 that receives sample data for learning from a data collection node (not illustrated), a gradient calculation processing unit 11 that calculates a gradient of a loss function of a model 13-n (neural network) to be learned per sample data piece with respect to each of weights of the model 13-n when the sample data is input, an aggregation processing unit 112 that generates and holds distribution data per weight, the distribution data being a numerical value obtained by aggregating gradients per sample data piece, a weight updating processing unit 113 that updates the weights of the model 13-n, a transmission unit 114 (third transmission unit), a reception unit 115 (third reception unit), a transmission unit 116 (fourth transmission unit), a reception unit 117 (fourth reception unit), and an aggregation processing unit 118.

The model 13-n (neural network) is a mathematical model built by the CPU 10-n in a software manner.

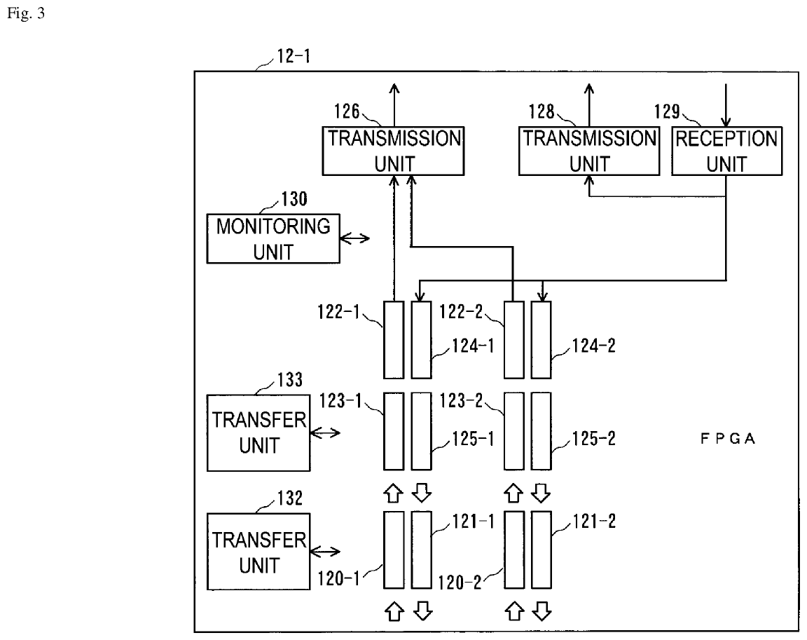

FIG. 3 is a functional block diagram of the FPGA 12-1 of the master node 1-1. The FPGA 12-1 functions as GPU reception buffers 120-1 and 120-2 (first reception buffers), GPU transmission buffers 121-1 and 121-2 (second transmission buffers), network transmission buffers 122-1, 122-2, 123-1, and 123-2 (first transmission buffers), network reception buffers 124-1, 124-2, 125-1, and 125-2 (second reception buffers), a transmission unit 126 (first transmission unit), a transmission unit 128 (second transmission unit), a reception unit 129 (second reception unit), a monitoring unit 130, a transfer unit 132 (first transfer unit), and a transfer unit 133 (second transfer unit).

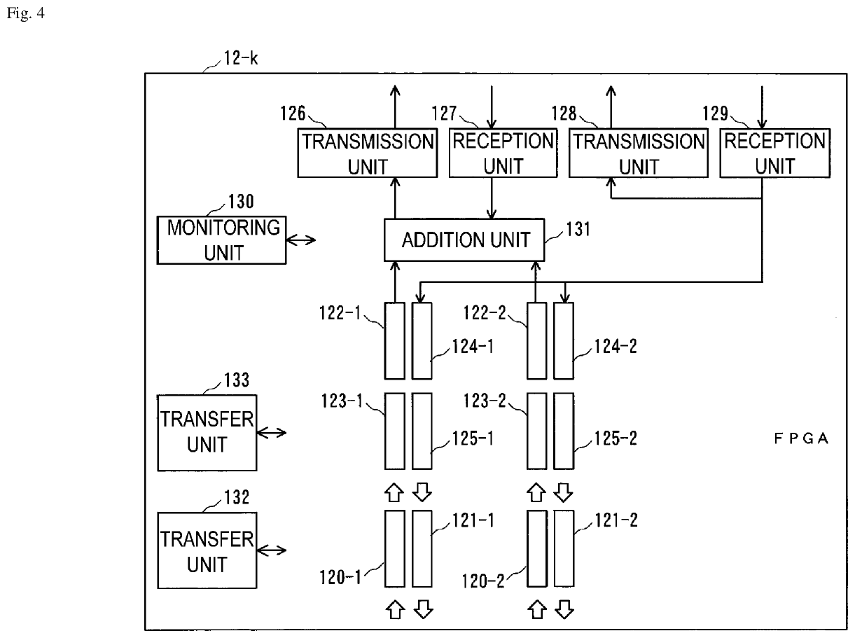

FIG. 4 is a functional block diagram of the FPGA 12-k of the slave node 1-k (k=2, . . . , N). The FPGA 12-k functions as the GPU reception buffers 120-1 and 120-2, the GPU transmission buffers 121-1 and 121-2, the network transmission buffers 122-1, 122-2, 123-1, and 123-2, the network reception buffers 124-1, 124-2, 125-1, and 125-2, the transmission unit 126, a reception unit 127 (first reception unit), the transmission unit 128, the reception unit 129, the monitoring unit 130, an addition unit 131, the transfer unit 132, and the transfer unit 133.

In the present embodiment, the number of GPU reception buffers 120-1 and 120-2 in the FPGA 12-n of each node 1-n is the same as the number of number of communication paths 20-1 and 20-2 configured in the network 2. The number of GPU transmission buffers 121-1 and 121-2 in the FPGA 12-n of each node 1-n is the same as the number of number of communication paths 20-1 and 20-2.

The FPGA 12-n of each node 1-n is provided with two network transmission buffers 122-1 and 123-1 corresponding to the communication path 20-1 and two network reception buffers 124-1 and 125-1 corresponding to the communication path 20-1. Furthermore, the FPGA 12-n of each node 1-n is provided with two network transmission buffers 122-2 and 123-2 corresponding to the communication path 20-2 and two network reception buffers 124-2 and 125-2 corresponding to the communication path 20-2.

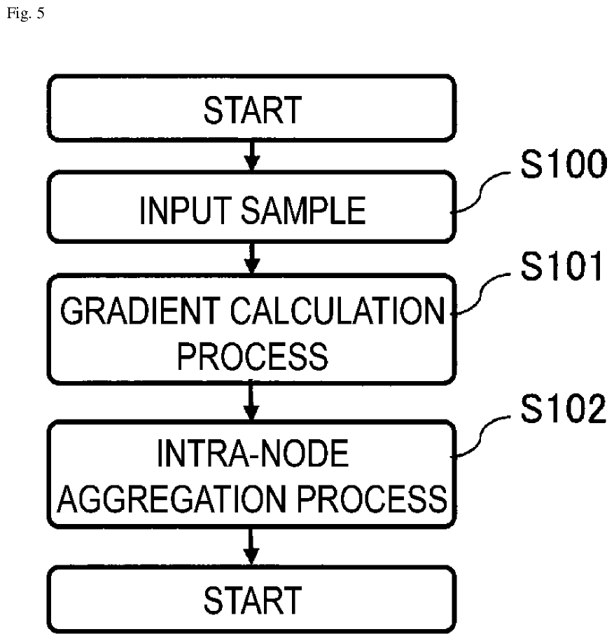

FIG. 5 is a flowchart illustrating a sample data input process, a gradient calculation process, and an intra-GPU aggregation process in each GPU 11-n-j (n=1, . . . , N, j=1, . . . , J) of the node 1-n.

The sample input unit 11o in each GPU 11-n-j of the node 1-n inputs different S pieces of sample data x[n, s] (s=1, . . . , S) (S is an integer of 2 or more) per mini batch from a data collecting node (not illustrated) to the gradient calculation processing unit in (step S100 in FIG. 5).

Note that the present invention is not limited to a sample data collecting method performed by a data collecting node and a method of dividing collected sample data into N×J sets and broadcasting the sets to the GPU 11-n-j of the node 1-n, and any method can be applied.

When sample data x[n, s] is input, the gradient calculation processing unit in in each GPU 11-n-j of the node 1-n calculates a gradient Gj[m, n, s] of a loss function of the mode 13-n per sample data piece x[n, s] with respect to each of M weights w[m] (m=1, . . . , M) (M is an integer of 2 or more) of the model 13-n to be learned (step S101 in FIG. 5).

The weights w[m] of the model 13-n, the loss function that is an indicator indicating the degree of poorness of performance of the model 13-n, and the gradient Gj[m, n, s] of the loss function are well-known techniques, and thus, detailed description thereof will be omitted.

Subsequently, the aggregation processing unit 112 in each GPU 11-n-j of the node 1-n generates and holds distributed data Dj[m, n] per weight w[m], the distributed data Dj[m, n] being a numerical value obtained by aggregating a gradient G[m, n, s] per sample data piece (step S102 in FIG. 5). A calculation equation for the distributed data Dj[m, n] is as follows.

Math 1

Dj[m,n]=Σ_{s=1, . . . ,S}Gj[m,n,s] (1)

Note that the gradient calculation process performed by the gradient calculation processing unit 111 and the intra-GPU aggregation process performed by the aggregation processing unit 112 can be performed in a pipelined manner in units of sample data (the gradient calculation process for any sample data piece and the intra-GPU aggregation process of aggregating gradients obtained from sample data piece immediately prior to the former sample data piece can be performed at the same time).

Furthermore, each node 1-n performs an inter-node Allreduce process after generating the distributed data Dj [m, n].

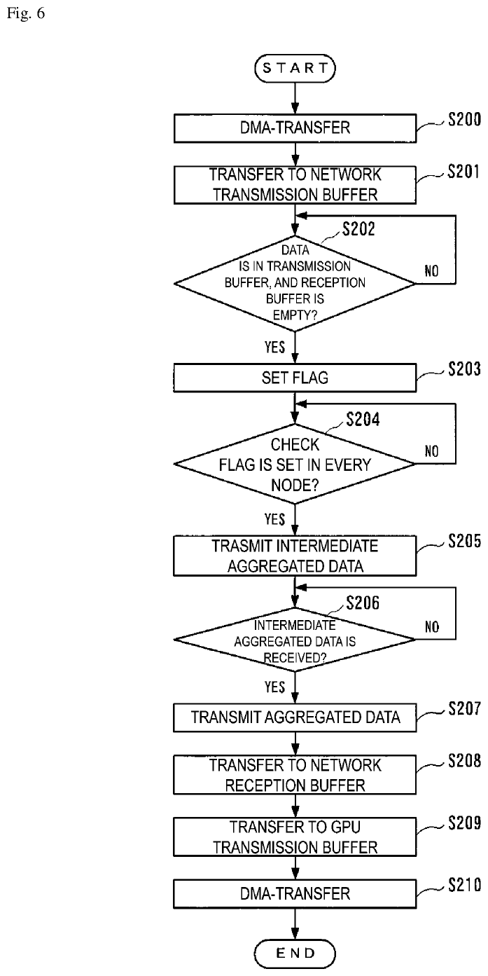

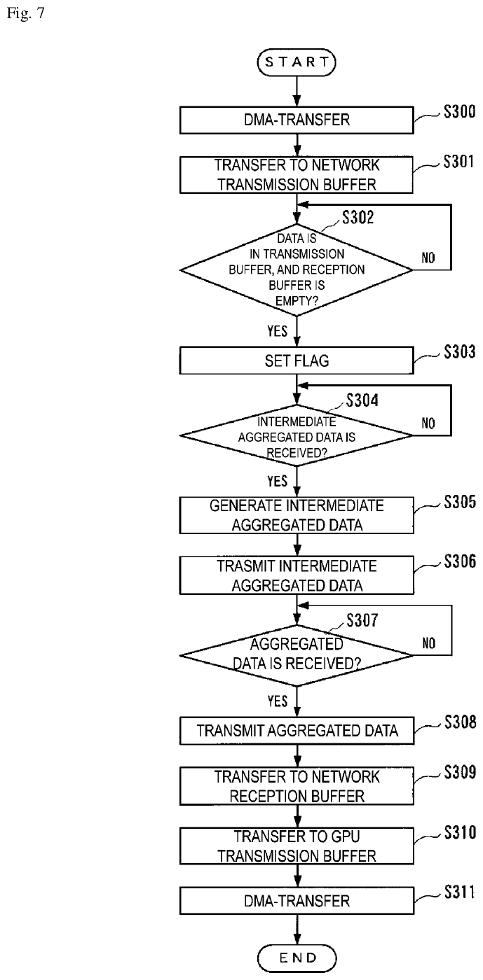

FIG. 6 is a flowchart illustrating the inter-node Allreduce process for the master node 1-1, and FIG. 7 is a flowchart illustrating the inter-node Allreduce process for the slave node 1-k (k=2, . . . , N).

The transmission unit 114 in each GPU 11-1-j of the master node 1-1 direct memory access (DMA)-transfers M pieces of distribution data Dj[m, 1] (m=1, . . . , M, j=1, . . . , J) generated by the aggregation processing unit 112 in the GPU 11-1-j to any one of the GPU reception buffer 120-1 and the GPU reception buffer 120-2 in the FPGA 12-1 of the master node 1-1 (step S200 in FIG. 6). The respective GPUs 11-1-j asynchronously DMA transfer data to the GPU reception buffers 120-1 and 120-2 different from each other. In a case that the DMA-transferring is congested, DMA-transferring thereafter is queued, and then, is started as soon as the prior DMA-transferring ends.

The transfer unit 132 in the FPGA 12-1 of the master node 1-1 monitors the network transmission buffers 122-1, 122-2, 123-1, and 123-2 in the FPGA 12-1. In a case that data is stored in the GPU reception buffer 120-1 in the FPGA 12-1 and any of the network transmission buffers 122-1 and 123-1 is empty, the transfer unit 132 transfers the data stored in the GPU reception buffer 120-1 to either the network transmission buffer 122-1 or 123-1 having an available space (step S201 in FIG. 6). In a case that data is stored in the GPU reception buffer 120-2 in the FPGA 12-1 and any of the network transmission buffers 122-2 and 123-2 is empty, the transfer unit 132 in the FPGA 12-1 transfers the data stored in the GPU reception buffer 120-2 to either the network transmission buffer 122-2 or 123-2 having an available space (step S201).

Similarly, the transmission unit 114 in each GPU 11-k-j of the slave node 1-k DMA-transfers M pieces of distribution data Dj[m, k] (m=1, . . . , M, j=1, . . . , J) generated by the aggregation processing unit 112 in the GPU 11-k-j to any one of the GPU reception buffer 120-1 and the GPU reception buffer 120-2 in the FPGA 12-k of the slave node 1-k (step S300 in FIG. 7).

The present embodiment gives a description assuming that the transmission unit 114 in each GPU 11-n-1 of the node 1-n transfers the distributed data D1[m, n] to the GPU reception buffer 120-1 in the FPGA 12-n, and the transmission unit 114 in each GPU 11-n-2 of the node 1-n transfers distributed data D2[m, n] to the GPU reception buffer 120-2 in the FPGA 12-n.

In a case that data is stored in the GPU reception buffer 120-1 in the FPGA 12-k and any of the network transmission buffers 122-1 and 123-1 is empty, the transfer unit 132 in the FPGA 12-k of the slave node 1-k transfers the data stored in the GPU reception buffer 120-1 to either the network transmission buffer 122-1 or 123-1 having an available space (step S301 in FIG. 7). In a case that data is stored in the GPU reception buffer 120-2 in the FPGA 12-k and any of the network transmission buffers 122-2 and 123-2 is empty, the transfer unit 132 in the FPGA 12-k transfers the data stored in the GPU reception buffer 120-2 to either the network transmission buffer 122-2 or 123-2 having an available space (step S301).

In a case that data is stored in the network transmission buffer 122-1 or 123-1 in the FPGA 12-1 of the master node 1-1 and any of the network reception buffers 124-1 and 125-1 in the FPGA 12-1 is empty (YES in step S202 in FIG. 6), the monitoring unit 130 in the FPGA 12-1 sets a check flag F1 corresponding to the communication path 20-1 (step S203 in FIG. 6). In a case that data is stored in the network transmission buffer 122-2 or 123-2 in the FPGA 12-1 and any of the network reception buffers 124-2 and 125-2 in the FPGA 12-1 is empty (YES in step S202), the monitoring unit 130 in the FPGA 12-1 sets a check flag F2 corresponding to the communication path 20-2 (step S203).

Similarly, in a case that data is stored in the network transmission buffer 122-1 or 123-1 in the FPGA 12-k of the slave node 1-k and any of the network reception buffers 124-1 and 125-1 in the FPGA 12-k is empty (YES in step S302 in FIG. 7), the monitoring unit 130 in the FPGA 12-k sets the check flag F1 corresponding to the communication path 20-1 (step S303 in FIG. 7). In a case that data is stored in the network transmission buffer 122-2 or 123-2 in the FPGA 12-k and any of the network reception buffers 124-2 and 125-2 in the FPGA 12-k is empty (YES in step S302), the monitoring unit 130 in the FPGA 12-k sets the check flag F2 corresponding to the communication path 20-2 (step S303).

The monitoring unit 130 in the FPGA 12-1 of the master node 1-1 monitors the check flag that is managed by the monitoring unit 130 in the FPGA 12-k of each slave node 1-k, and instructs the transmission unit 126 in the FPGA 12-1 to transmit the data in a case that the check flag F1 is set in every node 1-n including the master node 1-1 itself (YES in step S204 in FIG. 6). The transmission unit 126 in the FPGA 12-1 retrieves the distributed data D1[m, 1] stored in the network transmission buffer 122-1 or 123-1 in the FPGA 12-1, and transmits the retrieved data as intermediate aggregated data Rt1[m, 1] to the next numbered node 1-2 via the communication path 20-1 (step S205 in FIG. 6). The intermediate aggregated data Rt1[m, 1] at this time is the same as the distributed data D1[m, 1].

Rt1[m,1]=D1[m,1] (2)

The monitoring unit 130 in the FPGA 12-1 of the master node 1-1 instructs the transmission unit 126 in the FPGA 12-1 to transmit the data in a case that the check flag F2 is set in every node 1-n including the master node 1-1 itself (YES in step S204). The transmission unit 126 in the FPGA 12-1 retrieves the distributed data D2[m, 1] stored in the network transmission buffer 122-2 or 123-2 in the FPGA 12-1, and transmits the retrieved data as intermediate aggregated data Rt2[m, 1] to the next numbered node 1-2 via the communication path 20-2 (step S205).

Next, the reception unit 127 in the FPGA 12-i of the node 1-i (i=2, . . . , N−1) that is an intermediate one of the plurality of slave nodes 1-k (k=2, . . . , N) excluding the N-th node receives the intermediate aggregated data Rt1[m, i−1] (m=1, . . . , M) from the node 1-(i− 1) via the communication path 20-1 (step S304 in FIG. 7).

The addition unit 131 in the FPGA 12-i of the slave node 1-i (i=2, . . . , N−1) retrieves the distributed data D1[m, i] stored in the network transmission buffer 122-1 or 123-1 in the FPGA 12-i. Then, the addition unit 131 calculates a sum of the retrieved distributed data D1[m, i] and the intermediate aggregated data Rt1[m, i−1] received from the communication path 20-1 per corresponding weight w[m] to generate the intermediate aggregated data Rt1[m, i] (step S305 in FIG. 7). That is, the intermediate aggregated data Rt1[m, i] is constituted by M numerical values. A calculation equation for the intermediate aggregated data Rt1[m, i] is as follows.

Rt1[m,i]=Rt1[m,i−1]+D1[m,i] (3)

Then, the transmission unit 126 in the FPGA 12-i of the slave node 1-i transmits the intermediate aggregated data Rt1[m, i] generated by the addition unit 131 in the FPGA 12-i in response to the data reception from the communication path 20-1, to the next numbered node 1-(i+1) via the communication path 20-1 (step S306 in FIG. 7).

Similarly, the reception unit 127 in the FPGA 12-i of the slave node 1-i receives the intermediate aggregated data Rt2[m, i−1] from the node 1-(i− 1) via the communication path 20-2 (step S304). The addition unit 131 in the FPGA 12-i of the slave node 1-i retrieves the distributed data D2[m, i] stored in the network transmission buffer 122-2 or 123-2 in the FPGA 12-i. Then, the addition unit 131 calculates a sum of the retrieved distributed data D2[m, i] and the intermediate aggregated data Rt2[m, i−1] received from the communication path 20-2 per corresponding weight w[m] to generate the intermediate aggregated data Rt2[m, i] (step S305).

Then, the transmission unit 126 in the FPGA 12-i of the slave node 1-i transmits the intermediate aggregated data Rt2[m, i] generated by the addition unit 131 in the FPGA 12-i in response to the data reception from the communication path 20-2, to the next numbered node 1-(i+1) via the communication path 20-2 (step S306).

On the other hand, the reception unit 127 in the FPGA 12-N of the slave node 1-N receives the intermediate aggregated data Rt1[m, N−1] from the node 1-(N−1) via the communication path 20-1 (step S304).

The addition unit 131 in the FPGA 12-N of the slave node 1-N retrieves the distributed data D1[m, N] stored in the network transmission buffer 122-1 or 123-1 in the FPGA 12-N. Then, the addition unit 131 calculates a sum of the retrieved distributed data D1[m, N] and the intermediate aggregated data Rt1[m, N−1] received from the communication path 20-1 per corresponding weight w[m] to generate the intermediate aggregated data Rt1[m, N] (step S305). That is, the intermediate aggregated data Rt1[m, N] is constituted by M numerical values. A calculation equation for the intermediate aggregated data Rt1[m, N] is as follows.

Rt[m,N]=Rt1[m,N−1]+D1[m,N] (4)

Then, the transmission unit 126 in the FPGA 12-N of the slave node 1-N transmits the intermediate aggregated data Rt1[m, N] generated by the addition unit 131 in the FPGA 12-N in response to the data reception from the communication path 20-1, to the master node 1-1 via the communication path 20-1 (step S306).

In this manner, the intermediate aggregated data Rt1[m, N] constituted by M numerical values, which is calculated using the equations (2), (3), and (4), is calculated based on the distributed data D1[m, n] constituted by M numerical values generated at each node 1-n. A value of the intermediate aggregated data Rt1[m, N] can be expressed by the following equation.

Math 2

Rt1[m,N]=Σ_{n=1, . . . ,N}D1[m,n] (5)

Similarly, the reception unit 127 in the FPGA 12-N of the slave node 1-N receives the intermediate aggregated data Rt2[m, N−1] from the node 1-(N−1) via the communication path 20-2 (step S304). The addition unit 131 in the FPGA 12-N of the slave node 1-N retrieves the distributed data D2[m, N] stored in the network transmission buffer 122-2 or 123-2 in the FPGA 12-N. Then, the addition unit 131 calculates a sum of the retrieved distributed data D2[m, N] and the intermediate aggregated data Rt2[m, N−1] received from the communication path 20-2 per corresponding weight w[m] to generate the intermediate aggregated data Rt2[m, N] (step S305).

Then, the transmission unit 126 in the FPGA 12-N of the slave node 1-N transmits the intermediate aggregated data Rt1[m, N] generated by the addition unit 131 in the FPGA 12-N in response to the data reception from the communication path 20-2, to the master node 1-1 via the communication path 20-2 (step S306).

Next, the reception unit 129 in the FPGA 12-1 of the master node 1-1 receives the intermediate aggregated data Rt1[m, N] from the node 1-N via the communication path 20-1 (step S206 in FIG. 6).

The transmission unit 128 in the FPGA 12-1 of the master node 1-1 transmits the received intermediate aggregated data Rt1[m, N] as aggregated data R1[m] to the next numbered node 1-2 via the communication path 20-1 (step S207 in FIG. 6). The aggregated data R1[m] is the same as the intermediate aggregated data Rt[m, N].

Similarly, the transmission unit 128 in the FPGA 12-1 of the master node 1-1 transmits, in a case that the reception unit 129 receives the intermediate aggregated data Rt2[m, N] from the node 1-N via the communication path 20-2, the received intermediate aggregated data Rt2[m, N] as aggregated data R2[m] to the next numbered node 1-2 via the communication node 20-2 (step S207).

The reception unit 129 in the FPGA 12-1 of the master node 1-1 transfers the aggregated data R1[m] (or the intermediate aggregated data Rt1[m, N]) received from the node 1-N via the communication path 20-1 to either the network reception buffer 124-1 or 125-1 having an available space in the FPGA 12-1 (S208 in FIG. 6). Similarly, the reception unit 129 in the FPGA 12-1 of the master node 1-1 transfers the aggregated data R2[m] received from the node 1-N via the communication path 20-2 to either the network reception buffer 124-2 or 125-2 having an available space in the FPGA 12-1 (step S208).

The transfer unit 133 in the FPGA 12-1 of the master node 1-1 retrieves, once any of the network reception buffers 124-1 and 125-1 in the FPGA 12-1 is full, the data from the full network reception buffer to transfer the retrieved data to the GPU transmission buffer 121-1 in the FPGA 12-1 (step S209 in FIG. 6). Similarly, the transfer unit 133 in the FPGA 12-1 of the master node 1-1 retrieves, once any of the network reception buffers 124-2 and 125-2 in the FPGA 12-1 is full, the data from the full network reception buffer to transfer the retrieved data to the GPU transmission buffer 121-2 in the FPGA 12-1 (step S209).

The transfer unit 132 in the FPGA 12-1 of the master node 1-1 DMA-transfers the data stored in the GPU transmission buffer 121-1 in the FPGA 12-1 to the GPU 11-1-1 (step S210 in FIG. 6). Similarly, the transfer unit 132 in the FPGA 12-1 of the master node 1-1 DMA-transfers the data stored in the GPU transmission buffer 121-2 in the FPGA 12-1 to the GPU 11-1-2 (step S210).

As described above, aggregated data Rj[m] received from the node 1-N via the communication paths 20-1 and 20-2 is transferred to the GPUs 11-1-1 and 11-1-2.

On the other hand, the reception unit 129 in the FPGA 12-k of the slave node 1-k (k=2, . . . , N) receives the aggregated data R1[m] from the node 1-(k−1) via the communication path 20-1 (step S307 in FIG. 7).

The transmission unit 128 in the FPGA 12-k of the slave node 1-k transmits the received aggregated data R1[m] to the next numbered node 1-k⁺ (k⁺=k+1, where k⁺=1 in a case of k=N) via the communication path 20-1 (step S308 in FIG. 7).

Similarly, the transmission unit 128 in the FPGA 12-k of the slave node 1-k transmits, in a case that the reception unit 129 receives the aggregated data R2[m] from the node 1-(k−1) via the communication path 20-2, the received aggregated data R2[m] to the next numbered node 1-k⁺ via the communication node 20-2 (step S308).

The reception unit 129 in the FPGA 12-k of the slave node 1-k transfers the aggregated data R1[m] received from the node 1-(k−1) via the communication path 20-1 to either the network reception buffer 124-1 or 125-1 having an available space in the FPGA 12-k (step S309 in FIG. 7). Similarly, the reception unit 129 in the FPGA 12-k of the slave node 1-k transfers the aggregated data R2[m] received from the node 1-(k−1) via the communication path 20-2 to either the network reception buffer 124-2 or 125-2 having an available space in the FPGA 12-k (step S309).

The transfer unit 133 in the FPGA 12-k of the slave node 1-k retrieves, once any of the network reception buffers 124-1 and 125-1 in the FPGA 12-k is full, the data from the full network reception buffer to transfer the retrieved data to the GPU transmission buffer 121-1 in the FPGA 12-k (step S310 in FIG. 7). Similarly, the transfer unit 133 in the FPGA 12-k of the slave node 1-k retrieves, once any of the network reception buffers 124-2 and 125-2 in the FPGA 12-k is full, the data from the full network reception buffer to transfer the retrieved data to the GPU transmission buffer 121-1 in the FPGA 12-k (step S310).

The transfer unit 132 in the FPGA 12-k of the slave node 1-k DMA-transfers the data stored in the GPU transmission buffer 121-1 in the FPGA 12-k to the GPU 11-k−1 (step S311 in FIG. 7). Similarly, the transfer unit 132 in the FPGA 12-k of the slave node 1-k DMA-transfers the data stored in the GPU transmission buffer 121-2 in the FPGA 12-k to the GPU 11-k−2 (step S311).

As described above, the aggregated data Rj[m] received from the node 1-(k−1) via the communication paths 20-1 and 20-2 is transferred to the GPUs 11-k−1 and 11-k−2.

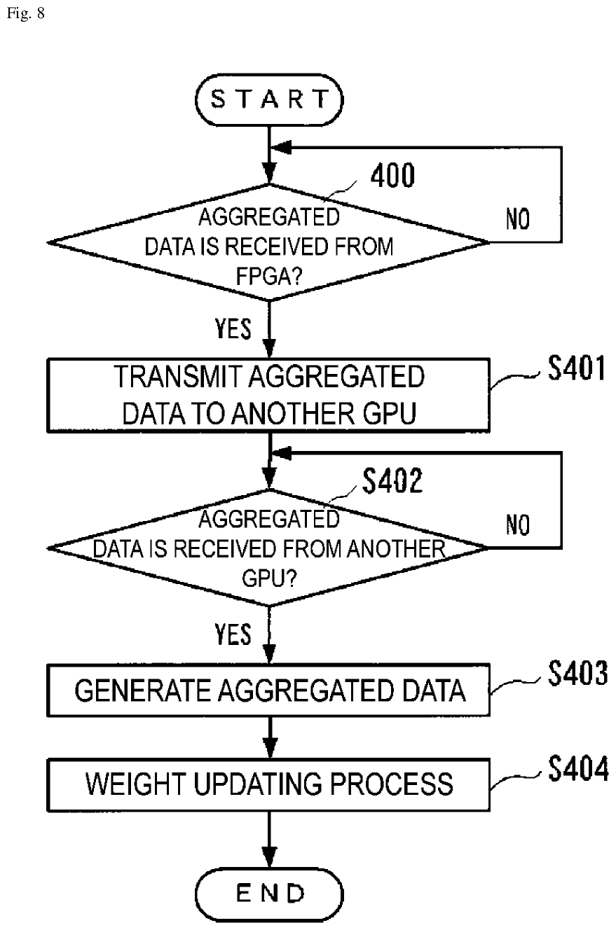

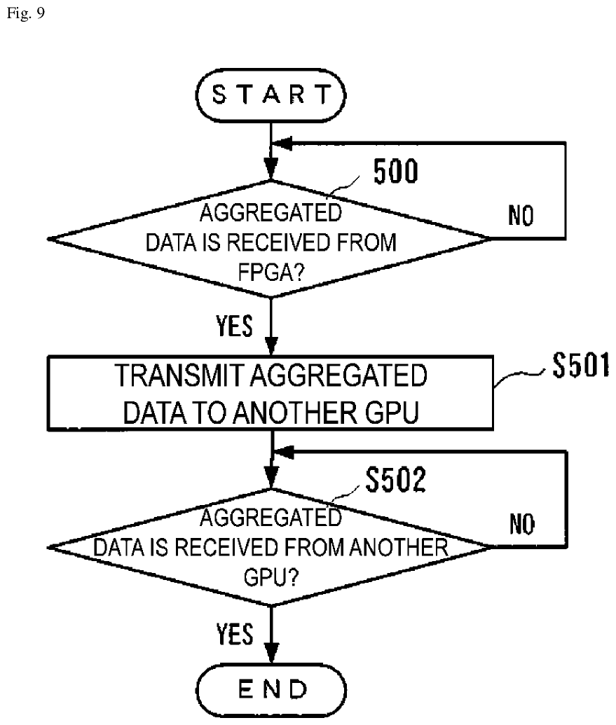

Next, the GPU 11-n-j of each node 1-n performs the inter-GPU Allreduce process and weight updating process in the node. FIG. 8 is a flowchart illustrating the inter-GPU Allreduce process and weight updating process of the GPU 11-n-1 in each node 1-n, and FIG. 9 is a flowchart illustrating the inter-GPU Allreduce process of the GPU 11-n-p (p=2, . . . , J) in each node 1-n. Note that here, the GPU 11-n-1 in each node 1-n performs, as the representative GPU of the node, the weighting update process.

The reception unit 115 in the GPU 11-n-1 of each node 1-n receives the aggregated data R1[m] stored in the GPU transmission buffer 121-1 in the FPGA 12-n (step S400 in FIG. 8).

The transmission unit 116 in the GPU 11-n-1 of each node 1-n transmits the aggregated data R1[m] received by the reception unit 115 in the GPU 11-n-1 to another GPU 11-n-2 (step S401 in FIG. 8).

On the other hand, the reception unit 115 in the GPU 11-n-2 of each node 1-n receives the aggregated data R2[m] stored in the GPU transmission buffer 121-2 in the FPGA 12-n (step S500 in FIG. 9).

The transmission unit 116 in the GPU 11-n-2 of each node 1-n transmits the aggregated data R2[m] received by the reception unit 115 in the GPU 11-n-2 to another GPU 11-n-1 (step S501 in FIG. 9).

The reception unit 117 in the GPU 11-n-1 of each node 1-n receives the aggregated data R2[m] transmitted from the GPU 11-n-2 (step S402 in FIG. 8).

The reception unit 117 in the GPU 11-n-2 of each node 1-n receives the aggregated data R1[m] transmitted from the GPU 11-n-1 (step S502 in FIG. 9).

Next, the aggregation processing unit 118 in the GPU 11-n-1 of each node 1-n calculates a sum of the aggregated data R1[m] received by the reception unit 115 in the GPU 11-n-1 and the aggregated data R2[m] received by the reception unit 117 per corresponding weight w[m] to generate aggregated data U[m] (step S403 in FIG. 8).

In this way, the sum of the data R1[m] obtained by aggregating the distributed data D1[m, n] calculated by the GPU 11-n-1 of each node 1-n and the data R2[m] obtained by aggregating the distributed data D2[m, n] calculated by the GPU 11-n-2 of each node 1-n can be determined as the aggregated data U[m].

The weight updating processing unit 113 in the GPU 11-n-1 of each node 1-n performs weight updating process to update the weight w [m] of the model 13-n in the node 1-n itself in accordance with the aggregated data U[m] (step S404 in FIG. 8). In the weight updating process, the weight w[m] is updated per number m so that a loss function is minimized on the basis of a gradient of the loss function which is indicated by the aggregated data U[m]. The updating of a weight w[m] is a well-known technique, and thus detailed description thereof will be omitted.

When one mini batch learning is terminated due to the termination of the weight updating process, each node 1-n continuously performs the next mini batch learning process on the basis of the updated weight w[m]. That is, each node 1-n receives sample data for the next mini batch learning from a data collecting node (not illustrated), and repeats the above-described mini batch learning process to improve the accuracy of inference of the model of the node 1-n itself.

In the present embodiment, a DMA wait time is reduced in each GPU 11-n-j of each node 1-n, and thus, each GPU 11-n-j can perform other processes by a reduced DMA wait time. In the present embodiment, a band of the GPU-FPGA bus can be effectively used by using the DMA transfer queue. In the present embodiment, a band of the network can be effectively used by increased network transmission buffer.

### Second Embodiment

Next, a second embodiment of the present invention will be described. In the present embodiment as well, the configuration of the distributed deep learning system and the process flow thereof are the same as those in the first embodiment, and thus, the description will be given using the reference signs in FIGS. 1 to 9.

In the first embodiment, each GPU 11-n-j (j=1, . . . , J) of the node 1-n (n=1, . . . , N) DMA-transfers the generated distributed data Dj[m, n] to either the GPU reception buffer 120-1 or the GPU reception buffer 120-2 in the FPGA 12-n of the node 1-n.

In contrast, in the present embodiment, each GPU 11-1-1 of the node 1-n exclusively uses the GPU reception buffer 120-1 and GPU transmission buffer 121-1 in the FPGA 12-n of the node 1-n. Each GPU 11-1-2 of the node 1-n exclusively uses the GPU reception buffer 120-2 and GPU transmission buffer 121-2 in the FPGA 12-n of the node 1-n.

Accordingly, the transmission unit 114 in each GPU 11-n-1 of the node 1-n DMA-transfers the distribution data D1[m, n] generated by the aggregation processing unit 112 in the GPU 11-n-1 to the GPU reception buffer 120-1 in the FPGA 12-n of the node 1-n (step S200 in FIG. 6). Similarly, the transmission unit 114 in each GPU 11-n-2 of the node 1-n DMA-transfers the distribution data D2[m, n] generated by the aggregation processing unit 112 in the GPU 11-n-2 to the GPU reception buffer 120-2 in the FPGA 12-n of the node 1-n (step S200).

The monitoring unit 130 in the FPGA 12-1 of the master node 1-1 instructs the transmission unit 126 in the FPGA 12-1 to transmit the data in a case that the check flag F1 is set in every node 1-n including the master node 1-1 itself and the check flag F2 is not set in at least one node (YES in step S204 in FIG. 6). The transmission unit 126 in the FPGA 12-1 retrieves the distributed data D1[m, 1] stored in the network transmission buffer 122-1 or 123-1 in the FPGA 12-1, and transmits the retrieved data as intermediate aggregated data Rt1[m, 1] to the next numbered node 1-2 via the communication path 20-1 (step S205 in FIG. 6).

Similarly, the monitoring unit 130 in the FPGA 12-1 of the master node 1-1 instructs the transmission unit 126 in the FPGA 12-1 to transmit the data in a case that the check flag F2 is set in every node 1-n including the master node 1-1 itself and the check flag F1 is not set in at least one node (YES in step S204). The transmission unit 126 in the FPGA 12-1 retrieves the distributed data D2[m, 1] stored in the network transmission buffer 122-2 or 123-2 in the FPGA 12-1, and transmits the retrieved data as intermediate aggregated data Rt2[m, 1] to the next numbered node 1-2 via the communication path 20-2 (step S205).

Other processing is the same as that described in the first embodiment. In this way, the present embodiment can realize the inter-node Allreduce process to aggregate the distributed data D1[m, n] calculated by the GPU 11-n-1 of each node 1-n to broadcast to the GPU 11-n-1 of each node 1-n, and the inter-node Allreduce process to aggregate the distributed data D2[m, n] calculated by the GPU 11-n-2 of each node 1-n to broadcast to the GPU 11-n-2 of each node 1-n.

In the present embodiment, a DMA wait time is reduced in each GPU 11-n-j of each node 1-n, and thus, each GPU 11-n-j can perform other processes by a reduced DMA wait time. In the present embodiment, a band of the GPU-FPGA bus can be effectively used by using the DMA transfer queue. In the present embodiment, a band of the network can be effectively used by increased network transmission buffer. In the present embodiment, the inter-node Allreduce process can be performed by one FPGA of each node 1-n, allowing power saving and space-saving to be achieved.

### Third Embodiment

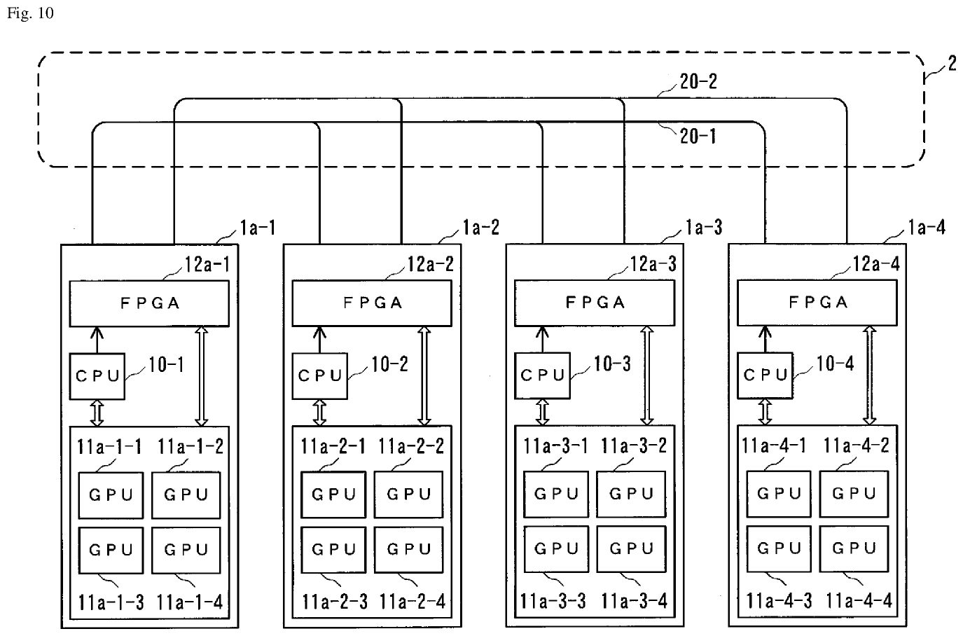

Next, a third embodiment of the present invention will be described. FIG. 10 is a block diagram illustrating a configuration of a distributed deep learning system according to a third embodiment of the present invention. The distributed deep learning system in the present embodiment includes N nodes 1a-n (n=1, . . . , N) and a network 2 connecting N nodes 1a-n to each other.

A patent node 1a-i includes a CPU 10-1, GPUs 11a-1-1 to 11a-1-4, and an FPGA 12a-1.

A slave node 1a-k (k=2, . . . , N) includes a CPU 10-k, GPUs 11a-k−1 to 11a-k−4, and an FPGA 12a-k.

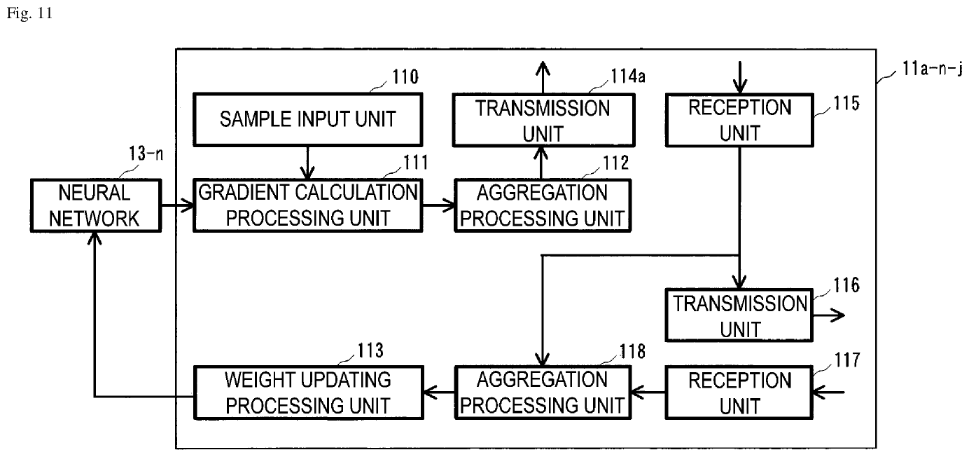

In the present embodiment, each node 1a-n is provided with four GPUs (that is, J=4). FIG. 11 is a functional block diagram of the GPU 11a-n-j (n=1, . . . , N, j=1, . . . , J). The GPU 11a-n-j functions as the sample input unit 110, the gradient calculation processing unit 11, the aggregation processing unit 112, the weight updating processing unit 113, a transmission unit 114a, the reception unit 115, the transmission unit 116, the reception unit 117, and the aggregation processing unit 118.

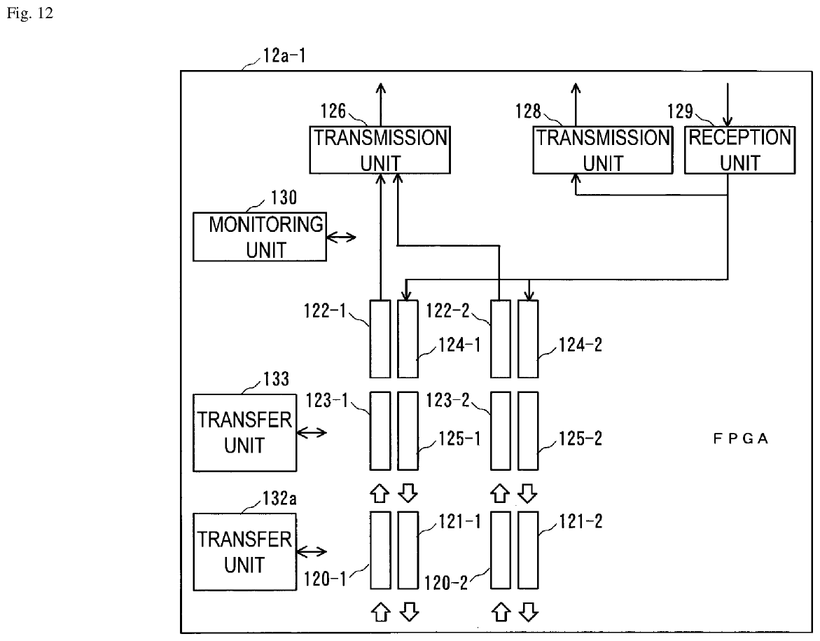

FIG. 12 is a functional block diagram of the FPGA 12a-1 of the master node 1a-1. The FPGA 12a-1 functions as the GPU reception buffers 120-1 and 120-2, the GPU transmission buffers 121-1 and 121-2, the network transmission buffers 122-1, 122-2, 123-1, and 123-2, the network reception buffers 124-1, 124-2, 125-1, and 125-2, the transmission unit 126, the transmission unit 128, the reception unit 129, the monitoring unit 130, a transfer unit 132a, and the transfer unit 133.

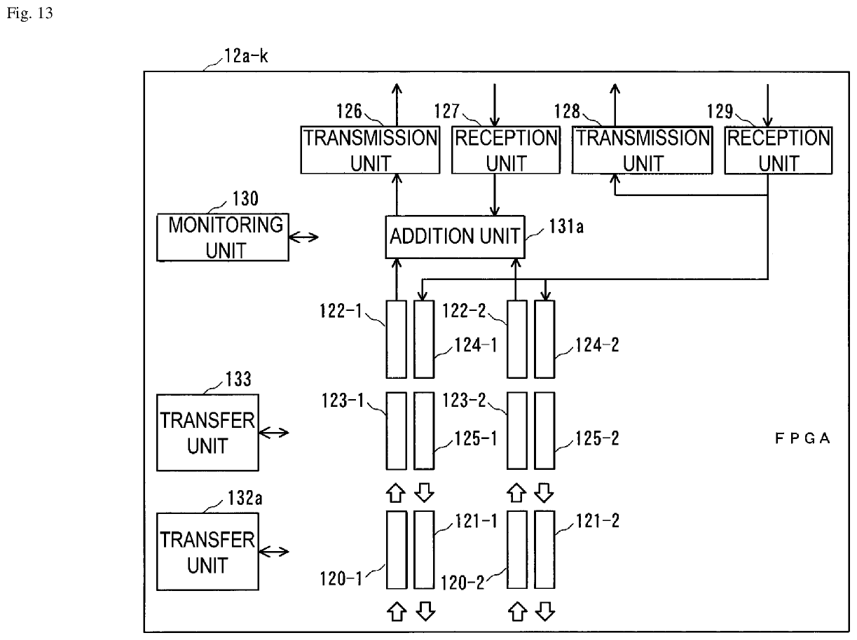

FIG. 13 is a functional block diagram of the FPGA 12a-k of the slave node 1a-k (k=2, . . . , N). The FPGA 12a-k functions as the GPU reception buffers 120-1 and 120-2, the GPU transmission buffers 121-1 and 121-2, the network transmission buffers 122-1, 122-2, 123-1, and 123-2, the network reception buffers 124-1, 124-2, 125-1, and 125-2, the transmission unit 126, the reception unit 127, the transmission unit 128, the reception unit 129, the monitoring unit 130, an addition unit 131a, the transfer unit 132a, and the transfer unit 133.

The sample data input process, the gradient calculation process, and the intra-GPU aggregation process in each GPU 11a-n-j (n=1, . . . , N, j=1, . . . , J) of the node 1a-n are the same as those described in the first embodiment.

The flow of the inter-node Allreduce process for the node 1a-n, which is similar to that in the first embodiment, will be described using the reference signs in FIGS. 6 and 7.

Similar to the first embodiment, the transmission unit 114a in each GPU 11a-1-j of the master node 1a-1 DMA-transfers the distribution data Dj[m, 1] generated by the aggregation processing unit 112 in the GPU 11a-1-j to any one of the GPU reception buffer 120-1 and the GPU reception buffer 120-2 in the FPGA 12a-1 of the master node 1a-1 (step S200 in FIG. 6). In a case that the DMA-transferring is congested, DMA-transferring thereafter is queued, and then, is started as soon as the prior DMA-transferring ends. At this time, the transmission unit 114a adds an identifier of the GPU 11a-1-j generating the distributed data Dj[m, 1] to the distributed data Dj[m, 1]. Processing in steps S201 to S203 in FIG. 6 is the same as that described in the first embodiment.

Similarly, the transmission unit 114a in each GPU 11a-k-j of the slave node 1a-k DMA-transfers the distribution data Dj[m, k] generated by the aggregation processing unit 112 in the GPU 11a-k-j to any one of the GPU reception buffer 120-1 and the GPU reception buffer 120-2 in the FPGA 12a-k of the slave node 1a-k (step S300 in FIG. 7). At this time, the transmission unit 114a adds an identifier of the GPU 11a-k-j generating the distributed data Dj[m, k] to the distributed data Dj[m, k]. Processing in steps S301 to S303 in FIG. 7 is the same as that described in the first embodiment.

The present embodiment gives a description assuming that the transmission units 114a in the GPU 11a-n-1 and the GPU 11a-n-3 of the node 1a-n transfer the distributed data D1[m, n] and D3[m, n] to the GPU reception buffer 120-1 in the FPGA 12a-n, and the transmission units 114a in the GPU 11a-n-2 and the GPU 11a-n-4 of the node 1a-n transfer the distributed data D2[m, n] and D4[m, n], respectively, to the GPU reception buffer 120-2 in the FPGA 12a-n.

The monitoring unit 130 in the FPGA 12a-1 of the master node 1a-1 instructs the transmission unit 126 in the FPGA 12a-1 to transmit the data in a case that the check flag F1 is set in every node 1a-n including the master node 1a-1 itself and the check flag F2 is not set in at least one node (YES in step S204 in FIG. 6). The transmission unit 126 in the FPGA 12a-1 retrieves the distributed data D1[m, 1] or D3[m, 1] stored in the network transmission buffer 122-1 or 123-1 in the FPGA 12a-1, and transmits the retrieved data as intermediate aggregated data Rt1[m, 1] or Rt3[m, 1] to the next numbered node 1a-2 via the communication path 20-1 (step S205 in FIG. 6).

The monitoring unit 130 in the FPGA 12a-1 of the master node 1a-1 instructs the transmission unit 126 in the FPGA 12a-1 to transmit the data in a case that the check flag F2 is set in every node 1a-n including the master node 1a-1 itself and the check flag F1 is not set in at least one node (YES in step S204). The transmission unit 126 in the FPGA 12a-1 retrieves the distributed data D2[m, 1] or D4[m, 1] stored in the network transmission buffer 122-2 or 123-2 in the FPGA 12a-1, and transmits the retrieved data as intermediate aggregated data Rt2[m, 1] or Rt4[m, 1] to the next numbered node 1a-2 via the communication path 20-2 (step S205).

Next, the reception unit 127 in the FPGA 12a-i of the node 1a-i (i=2, . . . , N−1) that is an intermediate one of the plurality of slave nodes 1a-k (k=2, . . . , N) excluding the N-th node receives the intermediate aggregated data Rt1[m, i−1] or Rt3[m, i−1] from the node 1a-(i−1) via the communication path 20-1 (step S304 in FIG. 7). The reception unit 127 in the FPGA 12a-i of the node 1a-i receives the intermediate aggregated data Rt2[m, i−1] or Rt4[m, i−1] from the node 1a-(i−1) via the communication path 20-2 (step S304).

The addition unit 131a in the FPGA 12a-i of the slave nodes 1a-i transitorily stores the intermediate aggregated data Rt1 [m, i−1], Rt2 [m, i−1], Rt3 [m, i−1], and Rt4 [m, i−1] received from the communication paths 20-1 and 20-2. Then, in a case that the GPU 11a-(i−1)-j deriving the intermediate aggregated data Rtj[m, i−1] received by the addition unit 131a in the FPGA 12a-i of the slave nodes 1a-i is in the same combination with the GPU 11a-i-j generating the distributed data Dj[m, i], and the distributed data Dj[m, i] is stored in any of the network transmission buffers 122-1, 123-1, 122-2, and 123-2 in the FPGA 12-i, the addition unit 131a retrieves the distributed data Dj[m, i]. Then, the addition unit 131a calculates a sum of the retrieved distributed data Dj[m, i] and the intermediate aggregated data Rtj[m, i−1] received from the communication path 20-1 or 20-2 per corresponding weight w[m] to generate the intermediate aggregated data Rtj[m, i] (step S305 in FIG. 7).

Note that the GPU 11a-(i−1)-j deriving the intermediate aggregated data Rtj[m, i−1] can be identified by the identifier added to the intermediate aggregated data Rtj[m, i−1]. Similarly, the GPU 11a-i-j deriving the distributed data Dj[m, i] can be identified by the identifier added to the distributed data Dj[m, i].

The transmission unit 126 in the FPGA 12-i of the slave node 1a-i transmits the intermediate aggregated data Rt1[m, i] or Rt3[m, i] generated by the addition unit 131a in the FPGA 12-i to the next numbered node 1a-(i+1) via the communication path 20-1 (step S306 in FIG. 7). The transmission unit 126 in the FPGA 12-i of the slave node 1a-i transmits the intermediate aggregated data Rt2[m, i] or Rt4[m, i] generated by the addition unit 131a in the FPGA 12-i to the next numbered node 1a-(i+1) via the communication path 20-2 (step S306).

[oio8] On the other hand, the reception unit 127 in the FPGA 12a-N of the slave node 1a-N receives the intermediate aggregated data Rt1[m, N−1] or Rt3[m, N−1] from the node 1a-(N−1) via the communication path 20-1 (step S304 in FIG. 7). The reception unit 127 in the FPGA 12a-N of the node 1a-N receives the intermediate aggregated data Rt2[m, N−1] or Rt4[m, N−1] from the node 1a-(N−1) via the communication path 20-2 (step S304).

The addition unit 131a in the FPGA 12a-N of the slave nodes 1a-N transitorily stores the intermediate aggregated data Rt1 [m, N−1], Rt2 [m, N−1], Rt3 [m, N−1], and Rt4 [m, N−1] received from the communication paths 20-1 and 20-2. Then, in a case that the GPU 11a-(N−1)-j deriving the intermediate aggregated data Rtj[m, N− i] received by the addition unit 131a in the FPGA 12a-N of the slave nodes 1a-N is in the same combination with the GPU 11a-N-j generating the distributed data Dj[m, N], and the distributed data Dj[m, N] is stored in any of the network transmission buffers 122-1, 123-1, 122-2, and 123-2 in the FPGA 12-N, the addition unit 131a retrieves the distributed data Dj[m, N]. Then, the addition unit 131a calculates a sum of the retrieved distributed data Dj[m, N] and the intermediate aggregated data Rtj[m, N−1] received from the communication path 20-1 or 20-2 per corresponding weight w[m] to generate the intermediate aggregated data Rtj[m, N] (step S305 in FIG. 7).

The transmission unit 126 in the FPGA 12-N of the slave node 1a-N transmits the intermediate aggregated data Rt1[m, N] or Rt3[m, N] generated by the addition unit 131a in the FPGA 12-N to the master node 1a-1 via the communication path 20-1 (step S306 in FIG. 7). The transmission unit 126 in the FPGA 12-N of the slave node 1a-N transmits the intermediate aggregated data Rt2[m, N] or Rt4[m, N] generated by the addition unit 131a in the FPGA 12-N to the master node 1a-1 via the communication path 20-2 (step S306).

Next, the reception unit 129 in the FPGA 12a-1 of the master node 1a-1 receives the intermediate aggregated data Rt1[m, N], Rt2[m, N], Rt3[m, N], and Rt4[m, N] from the node 1a-N via the communication path 20-1 or 20-2 (step S206 in FIG. 6).

The transmission unit 128 in the FPGA 12a-1 of the master node 1a-1 transmits the received intermediate aggregated data Rt1[m, N] or Rt3[m, N] as aggregated data R1[m] or R3[m] to the next numbered node 1a-2 via the communication path 20-1 (step S207 in FIG. 6). The transmission unit 128 in the FPGA 12a-1 of the master node 1a-1 transmits the received intermediate aggregated data Rt2[m, N] or Rt4[m, N] as aggregated data R2[m] or R4[m] to the next numbered node 1a-2 via the communication path 20-2 (step S207).

The reception unit 129 in the FPGA 12a-1 of the master node 1a-1 transfers the aggregated data R1[m], R2[m], R3[m], and R4[m] received from the node 1a-N via the communication path 20-1 or 20-2 to any of the network reception buffers 124-1, 125-1, 124-2, and 125-2 having an available space in the FPGA 12a-1 (S208 in FIG. 6).

Processing in step S209 in FIG. 6 is the same as that described in the first embodiment. The transfer unit 132a in the FPGA 12a-1 of the master node 1a-1 DMA-transfers, in a case that the aggregated data Rj[m] is stored in the GPU transmission buffer 121-1 or 12-2 in the FPGA 12a-1, the aggregated data Rj[m] to the corresponding GPU 11a-1-j (step S210 in FIG. 6).

As is obvious from the above description, the correspondence between the aggregated data Rj[m] and the GPU 11a-1-j can be identified by the identifier added to the aggregated data Rj[m].

As described above, the aggregated data Rj[m] received from the node 1a-N via the communication paths 20-1 and 20-2 is transferred to the GPU 11a-1-j.

On the other hand, the reception unit 129 in the FPGA 12a-k of the slave node 1a-k (k=2, . . . , N) receives the aggregated data R1[m], R2[m], R3[m], and R4[m] from the node 1a-(k−1) via the communication path 20-1 or 20-2 (step S307 in FIG. 7).

The transmission unit 128 in the FPGA 12a-k of the slave node 1a-k transmits the received aggregated data R1[m] or R3[m] to the next numbered node 1a-k+(k⁺=k⁺1, where k+=1 in a case of k=N) via the communication path 20-1 (step S308 in FIG. 7). The transmission unit 128 in the FPGA 12a-k of the slave node 1a-k transmits the received aggregated data R2[m] or R4[m] to the next numbered node 1a-k⁺ via the communication path 20-2 (step S308).

The reception unit 129 in the FPGA 12a-k of the slave node 1a-k transfers the aggregated data R1[m], R2[m], R3[m], and R4[m] received from the node 1a-(k−1) via the communication path 20-1 or 20-2 to any of the network reception buffers 124-1, 125-1, 124-2, and 125-2 having an available space in the FPGA 12a-k (S309 in FIG. 7).

Processing in step S310 in FIG. 7 is the same as that described in the first embodiment. The transfer unit 132a in the FPGA 12a-k of the slave node 1a-k DMA-transfers, in a case that the aggregated data Rj[m] is stored in the GPU transmission buffer 121-1 or 12-2 in the FPGA 12a-k, the aggregated data Rj[m] to the corresponding GPU 11a-k-j (step S311 in FIG. 7).

As described above, the aggregated data Rj[m] received from the node 1a-(k−1) via the communication paths 20-1 and 20-2 is transferred to the GPU 11a-k-j.

Next, the GPU 11a-n-j of each node 1a-n performs the inter-GPU Allreduce process and weight updating process in the node. The flows of the inter-GPU Allreduce process and the weight updating process, which are similar to those in the first embodiment, will be described using the reference signs in FIGS. 8 and 9.

The reception unit 115 in the GPU 11a-n-1 of each node 1a-n receives the aggregated data R1[m] from the FPGA 12a-n (step S400 in FIG. 8).

The transmission unit 116 in the GPU 11a-n-1 of each node 1a-n transmits the aggregated data R1[m] received by the reception unit 115 in the GPU 11a-n-1 to other GPUs 11a-n-p (p=2, . . . , J)(step S401 in FIG. 8).

On the other hand, the reception unit 115 in each of the GPUs 11a-n-p (p=2, . . . , J) of each node 1a-n receives the aggregated data Rp[m] transmitted from the FPGA 12a-n (step S500 in FIG. 9).

The transmission unit 116 in each of the GPUs 11a-n-p of each node 1a-n transmits the aggregated data Rp[m] received by the reception unit 115 in the GPU 11a-n-p to other GPUs 11a-n-q (q is a natural number equal to or less than J, and p≠q)(step S501 in FIG. 9).

The reception unit 117 in the GPU 11a-n-1 of each node 1a-n receives the aggregated data Rp[m] transmitted from the GPU 11a-n-p (step S402 in FIG. 8).

The reception unit 117 in the GPU 11a-n-p of each node 1a-n receives the aggregated data Rq[m] transmitted from the GPU 11a-n-q (step S502 in FIG. 9).

Next, the aggregation processing unit 118 in the GPU 11a-n-1 of each node 1a-n calculates a sum of the aggregated data R1[m] received by the reception unit 115 in the GPU 11a-n−1 and the aggregated data Rp[m] received by the reception unit 117 per corresponding weight w[m] to generate the aggregated data U[m] (step S403 in FIG. 8).

In this way, the sum of the data R1[m] obtained by aggregating the distributed data D1[m, n] calculated by the GPU 11a-n-1 of each node 1a-n, the data R2[m] obtained by aggregating the distributed data D2[m, n] calculated by the GPU 11a-n−2 of each node 1a-n, the data R3[m] obtained by aggregating the distributed data D3[m, n] calculated by the GPU 11a-n-3 of each node 1a-n, and the data R4[m] obtained by aggregating the distributed data D4[m, n] calculated by the GPU 11a-n−4 of each node 1a-n can be determined as the aggregated data U[m].

Processing in step S404 in FIG. 8 is the same as that described in the first embodiment.

In the present embodiment, a DMA wait time is reduced in each GPU 11a-n-j of each node 1a-n, and thus, each GPU 11a-n-j can perform other processes by a reduced DMA wait time. In the present embodiment, a band of the GPU-FPGA bus can be effectively used by using the DMA transfer queue. In the present embodiment, a band of the network can be effectively used by increased network transmission buffer. In the present embodiment, an aggregate throughput in the node can be improved by operating the GPUs 11a-n-j in parallel. In the present embodiment, each GPU 11a-n-j creates a Allreduce queue in parallel, and thus, the bus band and the network band can be more effectively used. In the present embodiment, the inter-node Allreduce process can be performed by one FPGA of each node 1a-n, allowing power saving and space-saving to be achieved.

In the past, the Allreduce process which is the slowest process in collective communication, has occurred in a node and between nodes. In contrast, in the present embodiment, the Allreduce process in the node is sped up by the number of parallel GPUs, and the Allreduce process between the nodes is also sped up by the number of parallel GPUs.

### Fourth Embodiment

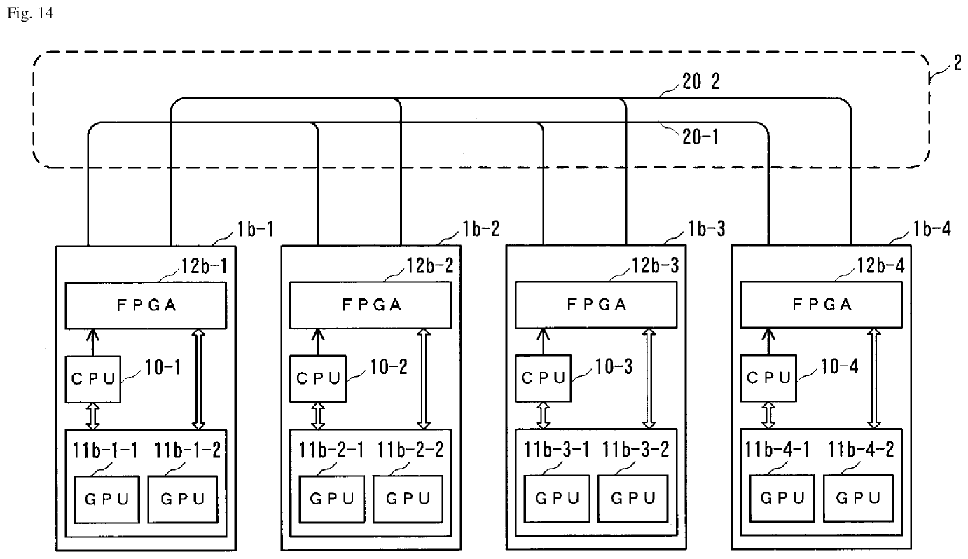

Next, a fourth embodiment of the present invention will be described. FIG. 14 is a block diagram illustrating a configuration of a distributed deep learning system according to a fourth embodiment of the present invention. The distributed deep learning system in the present embodiment includes N nodes 1b-n (n=1, . . . , N) and a network 2 connecting N nodes 1b-n to each other.

A patent node 1b-1 includes a CPU 10-1, GPUs 11b-1-1 and 11b-1-2, and an FPGA 12b-1.

A slave node 1b-k (k=2, . . . , N) includes a CPU 10-k, GPUs 11b-k-1 and 11a-k-2, and an FPGA 12b-k.

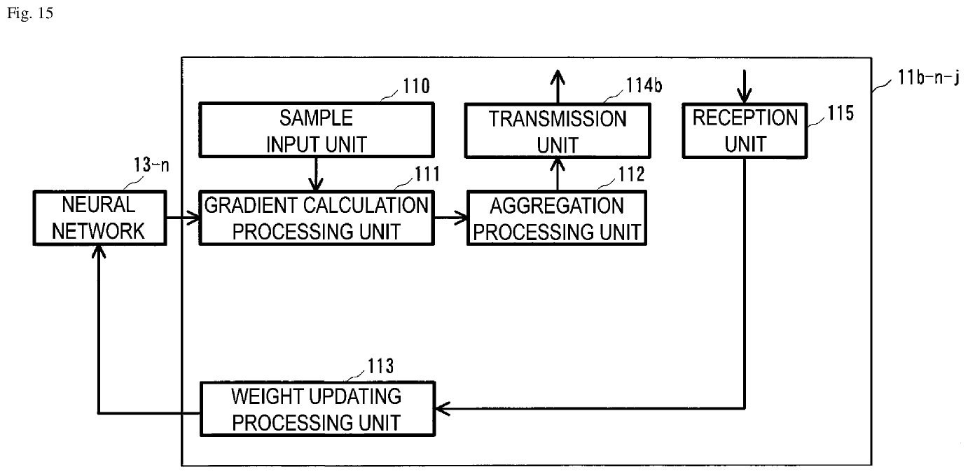

In the present embodiment, each node 1b-n is provided with two GPUs (that is, J=2). FIG. 15 is a functional block diagram of the GPU 11b-n-j (n=1, . . . , N, j=1, . . . , J). The GPU 11b-n-j functions as the sample input unit no, the gradient calculation processing unit 111, the aggregation processing unit 112, the weight updating processing unit 113, a transmission unit 114b, and the reception unit 115.

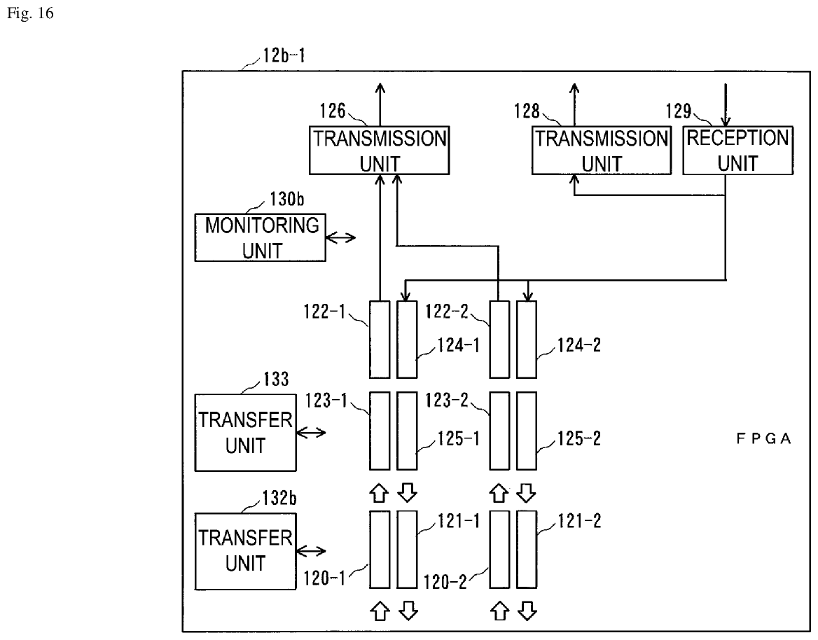

FIG. 16 is a functional block diagram of the FPGA 12b-1 of the master node 1b-1. The FPGA 12b-1 functions as the GPU reception buffers 120-1 and 120-2, the GPU transmission buffers 121-1 and 121-2, the network transmission buffers 122-1, 122-2, 123-1, and 123-2, the network reception buffers 124-1, 124-2, 125-1, and 125-2, the transmission unit 126, the transmission unit 128, the reception unit 129, a monitoring unit 130b, a transfer unit 132b, and the transfer unit 133.

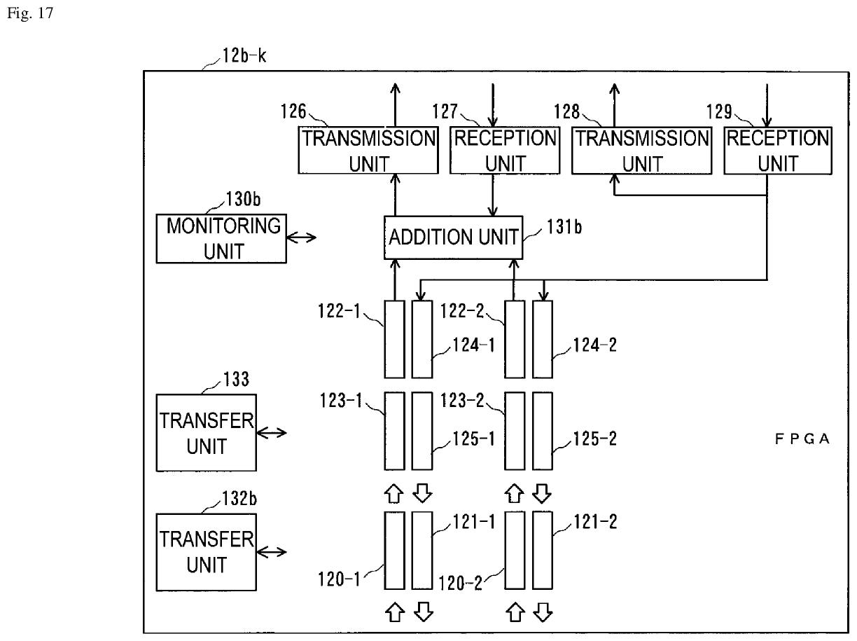

FIG. 17 is a functional block diagram of the FPGA 12b-k of the slave node 1b-k (k=2, . . . , N). The FPGA 12b-k functions as the GPU reception buffers 120-1 and 120-2, the GPU transmission buffers 121-1 and 121-2, the network transmission buffers 122-1, 122-2, 123-1, and 123-2, the network reception buffers 124-1, 124-2, 125-1, and 125-2, the transmission unit 126, the reception unit 127, the transmission unit 128, the reception unit 129, the monitoring unit 130b, an addition unit 131b, the transfer unit 132b, and the transfer unit 133.

The sample data input process, the gradient calculation process, and the intra-GPU aggregation process in each GPU 11b-n-j (n=1, . . . , N, j=1, . . . , J) of the node 1b-n are the same as those described in the first embodiment.

The flow of the inter-node Allreduce process for the node 1b-n, which is similar to that in the first embodiment, will be described using the reference signs in FIGS. 6 and 7.

Similar to the first embodiment, the transmission unit 114b in each GPU 11b-1-j of the master node 1b-1 DMA-transfers the distribution data Dj[m, 1] generated by the aggregation processing unit 112 in the GPU 11b-i-j to any one of the GPU reception buffer 120-1 and the GPU reception buffer 120-2 in the FPGA 12b-1 of the master node 1b-1 (step S200 in FIG. 6).

The transmission unit 114b in each GPU 11b-i-j selects any one of the GPU reception buffer 120-1 and the GPU reception buffer 120-2 that is not currently busy (or, not used by another GPU) and DMA-transfers the distributed data Dj[m, 1].

Processing in steps S201 to S203 in FIG. 6 is the same as that described in the first embodiment.

Similarly, the transmission unit 114b in each GPU 11b-k-j of the slave node 1b-k DMA-transfers the distribution data Dj[m, k] generated by the aggregation processing unit 112 in the GPU 11b-k-j to any of the GPU reception buffer 120-1 and the GPU reception buffer 120-2 that is not currently busy in the FPGA 12b-k of the slave node 1b-k (step S300 in FIG. 7).

The present embodiment gives a description assuming that the transmission unit 114b in each GPU 11b-n-1 of the node 1b-n transfers the distributed data D1[m, n] to the GPU reception buffer 120-1 in the FPGA 12b-n, and the transmission unit 114b in each GPU 11b-n-2 of the node 1b-n transfers distributed data D2[m, n] to the GPU reception buffer 120-2 in the FPGA 12b-n.

Processing in steps S301 to S303 in FIG. 7 is the same as that described in the first embodiment.

The monitoring unit 130b in the FPGA 12b-1 of the master node 1b-1 instructs the transmission unit 126 in the FPGA 12b-1 to transmit the data in a case that the check flag F1 and the check flag F2 are set in every node 1b-n including the master node 1b-1 itself (YES in step S204 in FIG. 6). The transmission unit 126 in the FPGA 12b-1 retrieves the distributed data D1[m, 1] stored in the network transmission buffer 122-1 or 123-1 in the FPGA 12b-1, and transmits the retrieved data as the intermediate aggregated data Rt1[m, 1] to the next numbered node 1b-2 via the communication path 20-1 (step S205 in FIG. 6). The transmission unit 126 in the FPGA 12b-1 retrieves the distributed data D2[m, 1] stored in the network transmission buffer 122-2 or 123-2 in the FPGA 12b-1, and transmits the retrieved data as the intermediate aggregated data Rt2[m, 1] to the next numbered node 1b-2 via the communication path 20-2 (step S205).

Next, the reception unit 127 in the FPGA 12b-2 of the slave node 1b-2 receives the intermediate aggregated data Rt1[m, 1] from the master node 1b-1 via the communication path 20-1 (step S304 in FIG. 7). The reception unit 127 in the FPGA 12b-2 of the slave node 1b-2 receives the intermediate aggregated data Rt2[m, 1] from the master node 1b-1 via the communication path 20-2 (step S304).

The addition unit 131b in the FPGA 12b-2 of the slave node 1b-2 transitorily stores the intermediate aggregated data Rt1 [m, i] and Rt2 [m, 1] received from the communication paths 20-1 and 20-2. The addition unit 131b retrieves the distributed data D1[m, 2] and D2[m, 2] generated by the GPUs 11b-2-1 and 11b-2-2 from any of the network transmission buffers 122-1, 123-1, 122-2, and 123-2 in the FPGA 12b-2. Then, the addition unit 131b calculates a sum of the retrieved distributed data D1[m, 2] and D2[m, 2], and the intermediate aggregated data Rt1[m, 1] and Rt2[m, 1] received from the communication paths 20-1 and 20-2 per corresponding weight w[m] to generate the intermediate aggregated data Rt[m, 2] (step S305 in FIG. 7).

The transmission unit 126 in the FPGA 12b-2 of the slave node 1b-2 transmits the intermediate aggregated data Rt[m, 2] generated by the addition unit 131b in the FPGA 12b-2 to the next numbered node 1b-3 via the communication paths 20-1 and 20-2 (step S306 in FIG. 7).

The reception unit 127 in the FPGA 12b-r of the slave node 1b-r (r=3, . . . , N) receives the intermediate aggregated data Rt[m, r−1] from the node 1b-(r−1) via the communication paths 20-1 and 20-2 (step S304 in FIG. 7).

The addition unit 131b in the FPGA 12b-r of the slave node 1b-r transitorily stores the intermediate aggregated data Rt[m, r−1] received from the communication paths 20-1 and 20-2. The addition unit 131b retrieves the distributed data D1[m, 2] and D2[m, 2] generated by the GPUs 11b-r-1 and 11b-r-2 from any of the network transmission buffers 122-1, 123-1, 122-2, and 123-2 in the FPGA 12b-r. Then, the addition unit 131b calculates a sum of the retrieved distributed data D1[m, 2] and D2[m, 2], and the intermediate aggregated data Rt[m, r−1] received from the communication paths 20-1 and 20-2 per corresponding weight w[m] to generate the intermediate aggregated data Rt[m, r] (step S305 in FIG. 7). At this time, the data from only any one of the communication paths 20-1 and 20-2 is used for the intermediate aggregated data Rt[m, r−1] used for the addition.

The transmission unit 126 in the FPGA 12b-r of the slave node 1b-r transmits the intermediate aggregated data Rt[m, r] generated by the addition unit 131b in the FPGA 12b-r to the next numbered node 1b-r⁺ (r⁺=r+1, where r⁺=1 in a case of r=N) via the communication paths 20-1 and 20-2 (step S306 in FIG. 7).

Next, the reception unit 129 in the FPGA 12b-1 of the master node 1b-1 receives the intermediate aggregated data Rt[m, N] from the node 1b-N via the communication paths 20-1 and 20-2 (step S206 in FIG. 6).

The transmission unit 128 in the FPGA 12b-1 of the master node 1b-1 transmits the received intermediate aggregated data Rt[m, N] as the aggregated data U[m] to the next numbered node 1b-2 via the communication paths 20-1 and 20-2 (step S207 in FIG. 6).

The reception unit 129 in the FPGA 12b-1 of the master node 1b-1 transfers the aggregated data U[m] received from the node 1b-N via the communication paths 20-1 and 20-2 to any of the network reception buffers 124-1 and 125-1 having an available space, and any of the network reception buffers 124-2 and 125-2 having an available space in the FPGA 12b-1 (step S208 in FIG. 6). At this time, the reception unit 129 transfers the aggregated data U[m] that is from only any one of the communication paths 20-1 and 20-2.

Processing in step S209 in FIG. 6 is the same as that described in the first embodiment. The transfer unit 132b in the FPGA 12b-1 of the master node 1b-1 DMA-transfers, in a case that the aggregated data U[m] is stored in the GPU transmission buffer 121-1 in the FPGA 12b-1, the aggregated data U[m] to the GPU 11b-1-1 (step S210 in FIG. 6). The transfer unit 132b in the FPGA 12b-1 of the master node 1b-1 DMA-transfers, in a case that the aggregated data U[m] is stored in the GPU transmission buffer 121-2 in the FPGA 12b-1, the aggregated data U[m] to the GPU 11b-1-2 (step S210).

As described above, the aggregated data U[m] received from the node 1b-N via the communication paths 20-1 and 20-2 is transferred to the GPU 11b-1-j.

On the other hand, the reception unit 129 in the FPGA 12b-k of the slave node 1b-k (k=2, . . . , N) receives the aggregated data U[m] from the node 1b-(k−1) via the communication paths 20-1 and 20-2 (step S307 in FIG. 7).

The transmission unit 128 in the FPGA 12b-k of the slave node 1b-k transmits the received aggregated data U[m] to the next numbered node 1b-k+(k⁺=k+1, where k⁺=1 in a case of k=N) via the communication paths 20-1 and 20-2 (step S308 in FIG. 7).

The reception unit 129 in the FPGA 12b-1 of the master node 1b-1 transfers the aggregated data U[m] received from the node 1b-(k−1) via the communication paths 20-1 and 20-2 to any of the network reception buffers 124-1 and 125-1 having an available space, and any of the network reception buffers 124-2 and 125-2 having an available space in the FPGA 12b-k (step S309 in FIG. 7).

Processing in step S310 in FIG. 7 is the same as that described in the first embodiment. The transfer unit 132b in the FPGA 12b-k of the slave node 1b-k DMA-transfers, in a case that the aggregated data U[m] is stored in the GPU transmission buffer 121-1 in the FPGA 12b-k, the aggregated data U[m] to the GPU 11b-k-1 (step S311 in FIG. 7). The transfer unit 132b in the FPGA 12b-k of the master node 1b-k DMA-transfers, in a case that the aggregated data U[m] is stored in the GPU transmission buffer 121-2 in the FPGA 12b-k, the aggregated data U[m] to the GPU 11b-k-2 (step S311).

As described above, the aggregated data U[m] received from the node 1b-(k−1) via the communication paths 20-1 and 20-2 is transferred to the GPU 11b-k-j.

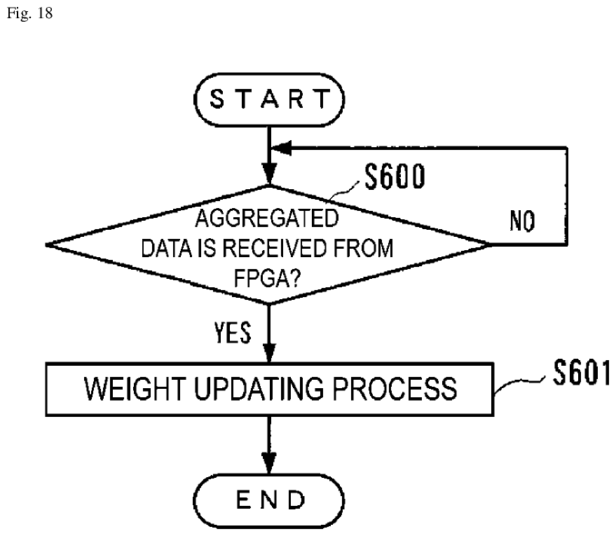

Next, the GPU 11b-n-j of each node 1b-n performs the weight updating process. FIG. 18 is a flowchart illustrating the weight updating process by the GPU 11b-n-1 of the node 1b-n. Note that here, the GPU 11b-n-1 in each node 1b-n performs, as the representative GPU of the node, the weighting update process.

The reception unit 115 in the GPU 11b-n-1 of each node 1b-n receives the aggregated data U[m] from the FPGA 12b-n (step S600 in FIG. 18).

The weight updating processing unit 113 in the GPU 11b-n-1 of each node 1b-n performs the weight updating process to update the weight w[m] of the model 13-n in the node 1b-n itself in accordance with the aggregated data U[m] (step S6oi in FIG. 18).

In the present embodiment, a DMA wait time is reduced in each GPU 11b-n-j of each node 1b-n, and thus, each GPU 11b-n-j can perform other processes by a reduced DMA wait time. In the present embodiment, a band of the GPU-FPGA bus can be effectively used by using the DMA transfer queue. In the present embodiment, a band of the network can be effectively used by increased network transmission buffer. In the present embodiment, the inter-node Allreduce process can be performed by one FPGA of each node 1b-n, allowing power saving and space-saving to be achieved.

In the present embodiment, the all aggregation processes in the Allreduce process which is the slowest process in collective communication are performed in hardware of the FPGA 12b-n, and thus, processing on the GPU side is lightened and a processing latency is also sped up. Each GPU 11b-n-j can select the GPU reception buffer that is not busy, and thus, a GPU reception buffer free wait time can be reduced, allowing the entire processing time to be shortened.

### Fifth Embodiment

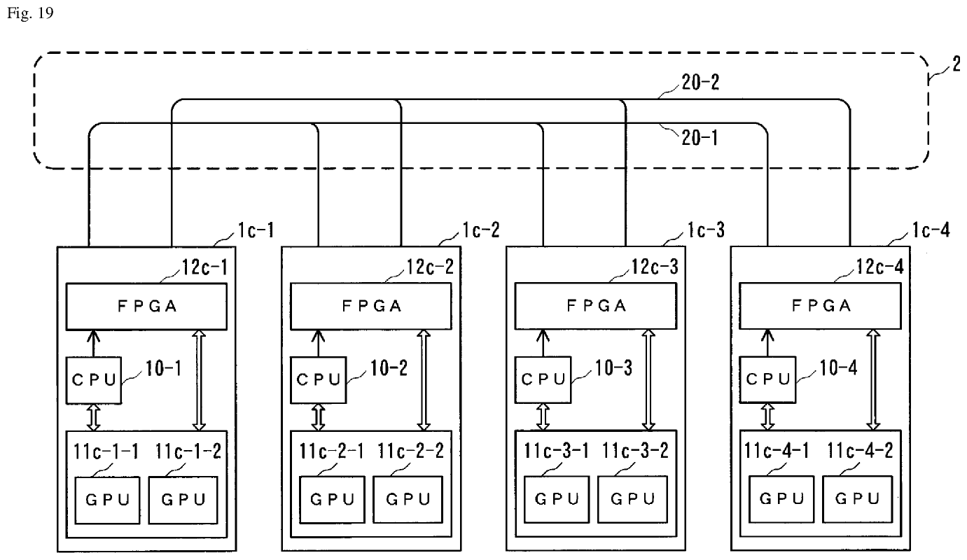

Next, a fifth embodiment of the present invention will be described. FIG. 19 is a block diagram illustrating a configuration of a distributed deep learning system according to a fifth embodiment of the present invention. The distributed deep learning system in the present embodiment includes N nodes 1c-n (n=1, . . . , N) and a network 2 connecting N nodes 1c-n to each other.

A patent node 1c-1 includes a CPU 10-1, GPUs 11c-1-1 and 11c-1-2, and an FPGA 12c-1.

A slave node 1c-k (k=2, . . . , N) includes a CPU 10-k, GPUs 11c-k-1 and 11a-k-2, and an FPGA 12c-k.

In the present embodiment, each node 1c-n is provided with two GPUs (that is, J=2). A configuration of the GPU 11c-n-j, which is similar to that of the GPU 11b-n-j in the fourth embodiment, is described using the reference signs in FIG. 15.

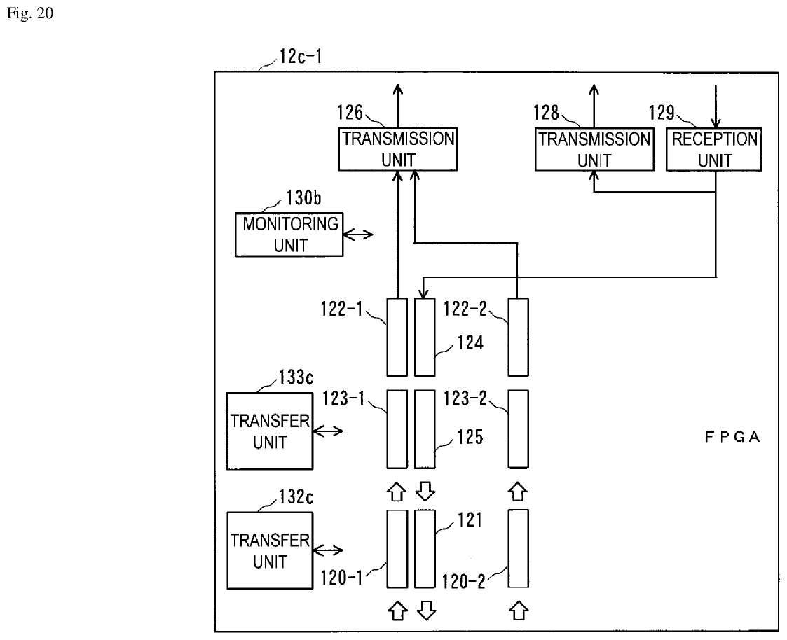

FIG. 20 is a functional block diagram of the FPGA 12c-1 of the master node 1c-1. The FPGA 12c-1 functions as the GPU reception buffers 120-1 and 120-2, the GPU transmission buffer 121, the network transmission buffers 122-1, 122-2, 123-1, and 123-2, the network reception buffers 124 and 125, the transmission unit 126, the transmission unit 128, the reception unit 129, the monitoring unit 130b, a transfer unit 132c, and a transfer unit 133c.

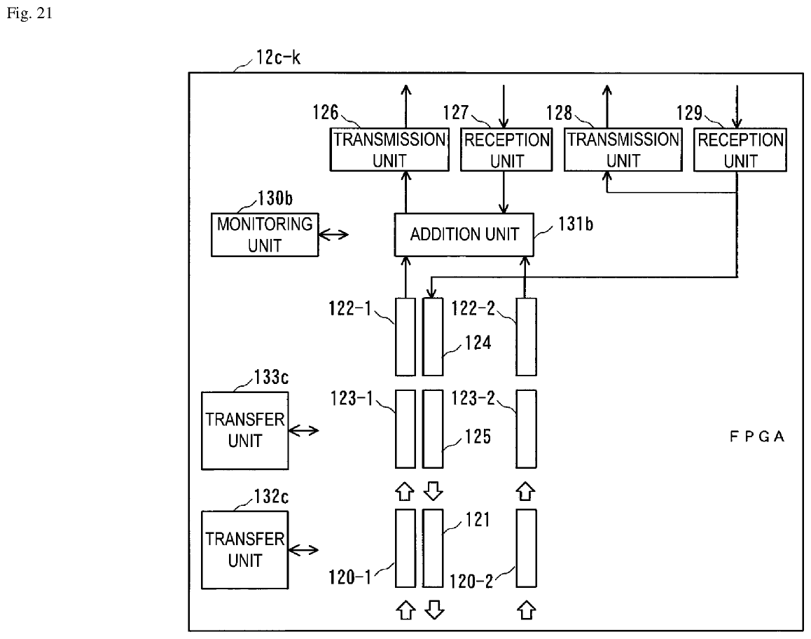

FIG. 21 is a functional block diagram of the FPGA 12c-k of the slave node 1c-k (k=2, . . . , N). The FPGA 12c-k functions as the GPU reception buffers 120-1 and 120-2, the GPU transmission buffer 121, the network transmission buffers 122-1, 122-2, 123-1, and 123-2, the network reception buffers 124 and 125, the transmission unit 126, the reception unit 127, the transmission unit 128, the reception unit 129, the monitoring unit 130b, the addition unit 131b, the transfer unit 132c, and the transfer unit 133c.

In the present embodiment, the FPGA 12c-n of each node 1c-n is provided with the GPU reception buffers 120-1 and 120-2 the number of which is the same as the number of communication paths 20-1 and 20-2, and the GPU transmission buffer 121 common to the communication paths 20-1 and 20-2. The FPGA 12c-n of each node 1c-n is provided with two network transmission buffers 122-1 and 123-1 corresponding to the communication path 20-1. The FPGA 12c-n of each node 1c-n is provided with two network transmission buffers 122-2 and 123-2 corresponding to the communication path 20-2. Furthermore, the FPGA 12c-n of each node 1c-n is provided with two network reception buffers 124 and 125 corresponding to the communication paths 20-1 and 20-2.

The sample data input process, the gradient calculation process, and the intra-GPU aggregation process in each GPU 11c-n-j (n=1, . . . , N, j=1, . . . , J) of the node 1c-n are the same as those described in the first embodiment.

The flow of the inter-node Allreduce process for the node 1c-n, which is similar to that in the first embodiment, will be described using the reference signs in FIGS. 6 and 7.

The transmission unit 114b in each GPU 11c-1-j of the master node 1c-1 DMA-transfers the distribution data Dj[m, i] generated by the aggregation processing unit 112 in the GPU 11c-1-j to any one of the GPU reception buffer 120-1 and the GPU reception buffer 120-2 in the FPGA 12c-i of the master node 1c-1 (step S200 in FIG. 6).

Similar to the fourth embodiment, the transmission unit 114b in each GPU 11c-1-j selects any one of the GPU reception buffer 120-1 and the GPU reception buffer 120-2 that is not currently busy (or, not used by another GPU) and DMA-transfers the distributed data Dj[m, i].

Processing in steps S201 to S207 in FIG. 6 is the same as that described in the fourth embodiment.

The transmission unit 114b in each GPU 11c-k-j of the slave node 1c-k DMA-transfers the distribution data Dj[m, k] generated by the aggregation processing unit 112 in the GPU 11c-k-j to any of the GPU reception buffer 120-1 and the GPU reception buffer 120-2 that is not currently busy in the FPGA 12c-k of the slave node 1c-k (step S300 in FIG. 7).

Processing in steps S301 to S308 in FIG. 7 is the same as that described in the fourth embodiment.

The reception unit 129 in the FPGA 12c-i of the master node 1c-1 transfers the aggregated data U[m] received from the node 1c-N via the communication paths 20-1 and 20-2 to either the network reception buffer 124 or 125 having an available space in the FPGA 12c-1 (step S208 in FIG. 6). At this time, the reception unit 129 transfers the aggregated data U[m] that is from only any one of the communication paths 20-1 and 20-2.

The transfer unit 133c in the FPGA 12c-i of the master node 1c-1 retrieves, once any of the network reception buffers 124 and 125 in the FPGA 12c-i is full, the data from the full network reception buffer to transfer the retrieved data to the GPU transmission buffer 121 in the FPGA 12c-1 (step S209 in FIG. 6).

The transfer unit 132c in the FPGA 12c-1 of the master node 1c-1 DMA-transfers the data stored in the GPU transmission buffer 121 in the FPGA 12c-i to the GPU 11c-1-1 and the GPU 11c-1-2 (step S210 in FIG. 6).

As described above, the aggregated data U[m] received from the node 1c-N via the communication paths 20-1 and 20-2 is broadcast-transferred to the GPUs 11c-1-1 and 11c-1-2.

The reception unit 129 in the FPGA 12c-k of the slave node 1c-k transfers the aggregated data U[m] received from the node 1c-(k−1) via the communication paths 20-1 and 20-2 to either the network reception buffer 124 or 125 having an available space in the FPGA 12c-k (step S309 in FIG. 7). At this time, the reception unit 129 transfers the aggregated data U[m] that is from only any one of the communication paths 20-1 and 20-2.

The transfer unit 133c in the FPGA 12c-k of the slave node 1c-k retrieves, once any of the network reception buffers 124 and 125 in the FPGA 12c-k is full, the data from the full network reception buffer to transfer the retrieved data to the GPU transmission buffer 121 in the FPGA 12c-k (step S310 in FIG. 7).

The transfer unit 132c in the FPGA 12c-k of the slave node 1c-k DMA-transfers the data stored in the GPU transmission buffer 121 in the FPGA 12c-k to the GPU 11c-k-1 and the GPU 11c-k−2 (step S311 in FIG. 7).

As described above, the aggregated data U[m] received from the node 1c-(k−1) via the communication paths 20-1 and 20-2 is broadcast-transferred to the GPUs 11c-k−1 and 11c-k-2.

The weight updating process of the GPU 11c-n-j in each node 1c-n is similar to that in the fourth embodiment.

In the present embodiment, a DMA wait time is reduced in each GPU 11c-n-j of each node 1c-n, and thus, each GPU 11c-n-j can perform other processes by a reduced DMA wait time. In the present embodiment, a band of the GPU-FPGA bus can be effectively used by using the DMA transfer queue. In the present embodiment, a band of the network can be effectively used by increased network transmission buffer. In the present embodiment, the inter-node Allreduce process can be performed by one FPGA of each node 1c-n, allowing power saving and space-saving to be achieved. In the present embodiment, the number of network reception buffers and GPU transmission buffers in the FPGA can be reduced compared to the first to fourth embodiments, which makes it possible to reduce a circuit area and reduce costs.

In the present embodiment, the all aggregation processes in the Allreduce process which is the slowest process in collective communication are performed in hardware of the FPGA 12c-n, and thus, processing on the GPU side is lightened and a processing latency is also sped up. Each GPU 11c-n-j can select the GPU reception buffer that is not busy, and thus, a GPU reception buffer free wait time can be reduced, allowing the entire processing time to be shortened.

### Sixth Embodiment

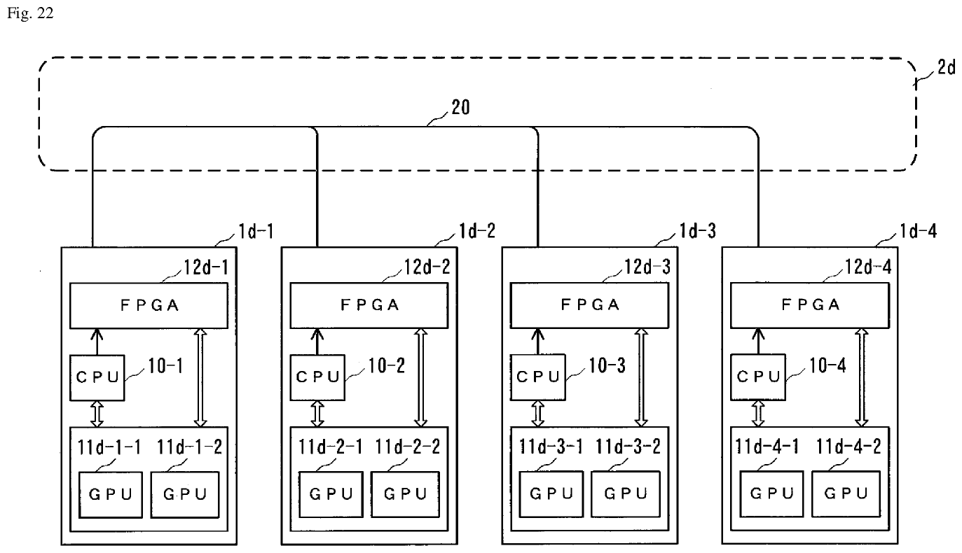

Next, a sixth embodiment of the present invention will be described. FIG. 22 is a block diagram illustrating a configuration of a distributed deep learning system according to the sixth embodiment of the present invention. The distributed deep learning system in the present embodiment includes N nodes 1d-n (n=1, . . . , N) and a network 2d connecting N nodes 1d-n to each other. One communication path 20 is configured in the network 2d.

A patent node 1d-1 includes a CPU 10-1, GPUs 11d-1-1 and 11d-1-2, and an FPGA 12d-1.

A slave node 1d-k (k=2, . . . , N) includes a CPU 10-k, GPUs 11d-k-1 and 11d-k-2, and an FPGA 12d-k.

In the present embodiment, each node 1d-n is provided with two GPUs (that is, J=2). A configuration of the GPU 11d-n-j, which is similar to that of the GPU 11b-n-j in the fourth embodiment, is described using the reference signs in FIG. 15.

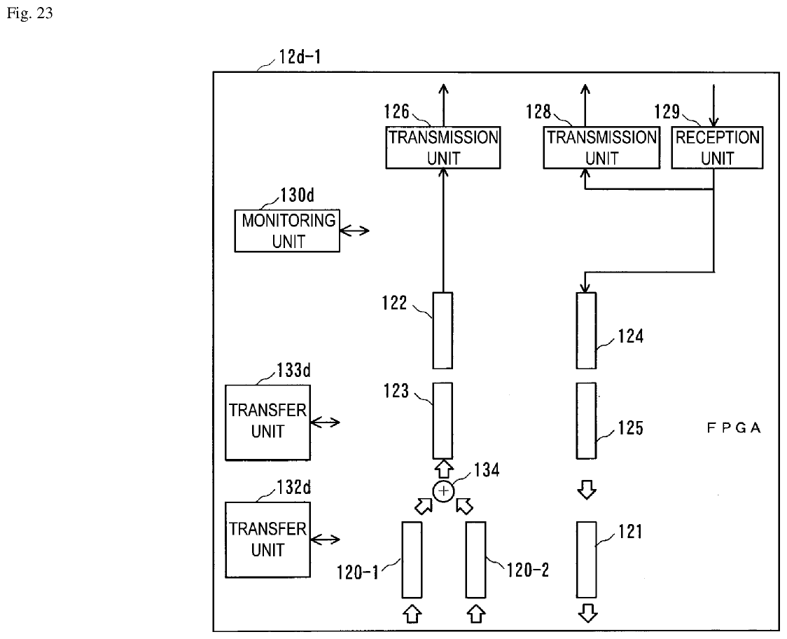

FIG. 23 is a functional block diagram of the FPGA 12d-1 of the master node 1d-1. The FPGA 12d-1 functions as the GPU reception buffers 120-1 and 120-2, the GPU transmission buffer 121, the network transmission buffers 122 and 123, the network reception buffers 124 and 125, the transmission unit 126, the transmission unit 128, the reception unit 129, a monitoring unit 130d, a transfer unit 132d, and a transfer unit 133d and an addition unit 134 (first addition unit).

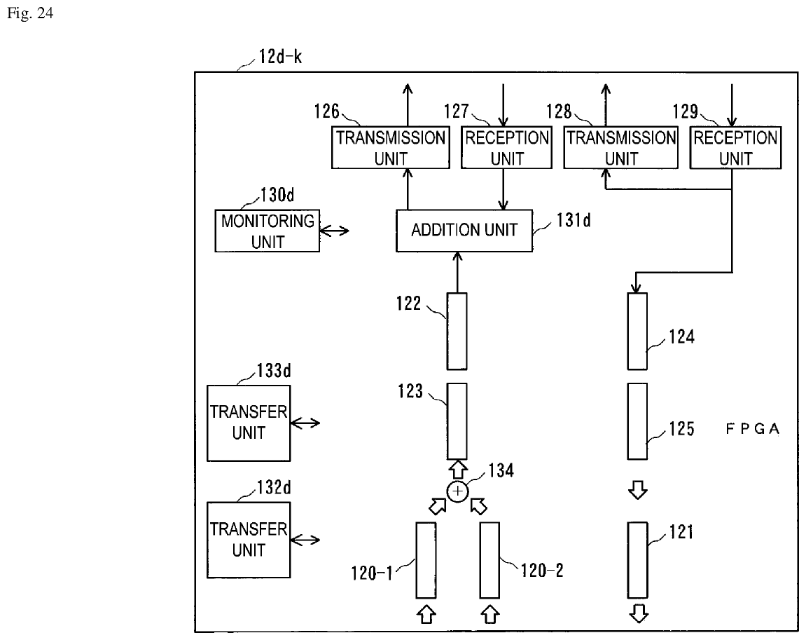

FIG. 24 is a functional block diagram of the FPGA 12d-k of the slave node 1d-k (k=2, . . . , N). The FPGA 12d-k functions as the GPU reception buffers 120-1 and 120-2, the GPU transmission buffer 121, the network transmission buffers 122 and 123, the network reception buffers 124 and 125, the transmission unit 126, the reception unit 127, the transmission unit 128, the reception unit 129, the monitoring unit 130d, an addition unit 131d (second addition unit), the transfer unit 132d, the transfer unit 133d, and the addition unit 134 (first addition unit).

In the present embodiment, the FPGA 12d-n of each node 1d-n is provided with the GPU reception buffers 120-1 and 120-2 the number of which is the same as the number of GPUs 11d-n-j, and the GPU transmission buffers 121 the number of which is the same as the number of communication paths 20. The FPGA 12d-n of each node 1d-n is provided with two network transmission buffers 122 and 123 and two network reception buffers 124 and 125.

The sample data input process, the gradient calculation process, and the intra-GPU aggregation process in each GPU 11d-n-j (n=1, . . . , N, j=1, . . . , J) of the node 1d-n are the same as those described in the first embodiment.

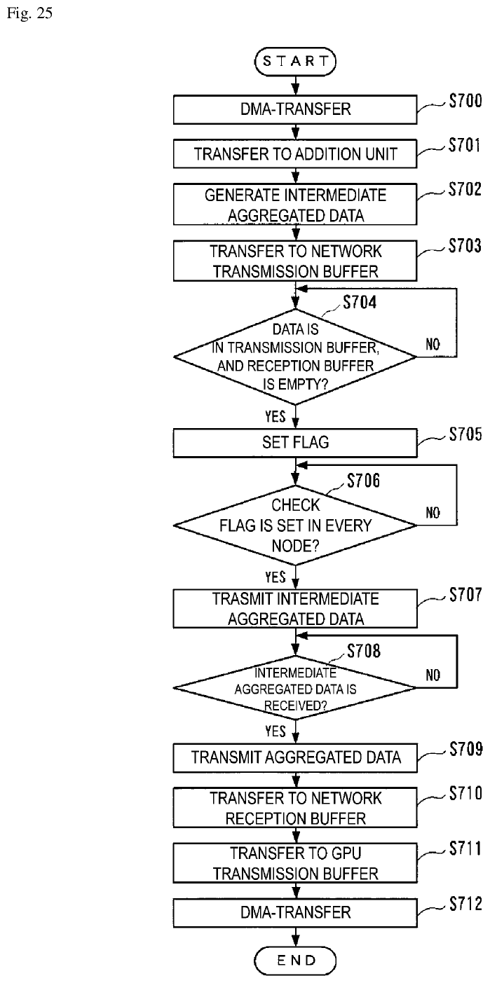

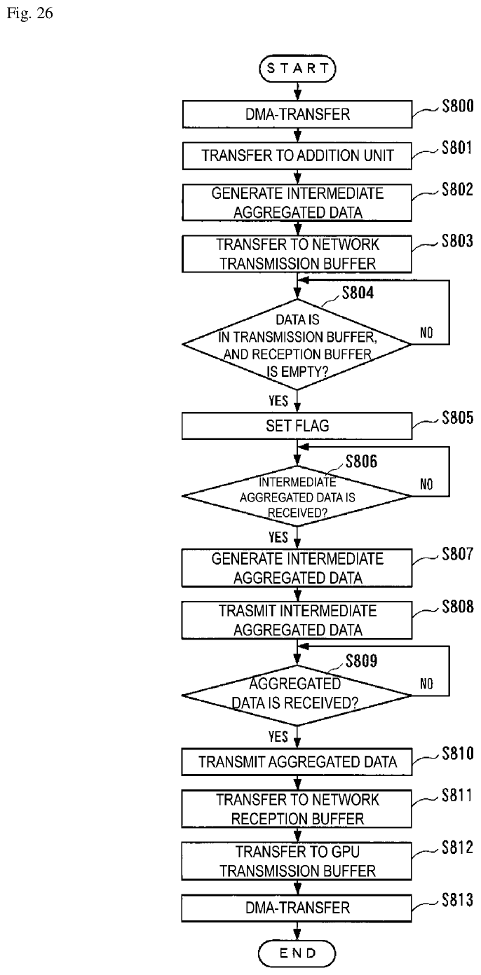

FIG. 25 is a flowchart illustrating the inter-node Allreduce process for the master node 1d-1, and FIG. 26 is a flowchart illustrating the inter-node Allreduce process for the slave node 1d-k (k=2, . . . , N).

The transmission unit 114b in each GPU 11d-i-j of the master node 1d-1 DMA-transfers the distribution data Dj[m, i] generated by the aggregation processing unit 112 in the GPU 11d-i-j to any one of the GPU reception buffer 120-1 and the GPU reception buffer 120-2 in the FPGA 12d-1 of the master node 1d-1 (step S700 in FIG. 25).

Similar to the fourth embodiment, the transmission unit 114b in each GPU 11d-i-j selects any one of the GPU reception buffer 120-1 and the GPU reception buffer 120-2 that is not currently busy (or, not used by another GPU) and DMA-transfers the distributed data Dj[m, i].

In a case that data is stored in the both GPU reception buffers 120-1 and 120-2 in the FPGA 12d-1 of the master node 1d-1 and any of the network transmission buffers 122 and 123 is empty, the transfer unit 132d in the FPGA 12d-1 transfers the data stored in the GPU reception buffers 120-1 and 120-2 to the addition unit 134 (step S701 in FIG. 25).

The addition unit 134 in the FPGA 12d-1 of the master node 1d-1 calculates a sum of the distributed data D1[m, 1] and D2[m, 1] received from the GPU reception buffers 120-1 and 120-2 per corresponding weight w[m] to generate the intermediate aggregated data Rt[m, 1](step S702 in FIG. 25). The addition unit 134 transfers the intermediate aggregated data Rt[m, 1] to either the network transmission buffer 122 or 123 having an available space in the FPGA 12d-1 (step S703 in FIG. 25).

The transmission unit 114b in each GPU 11d-k-j of the slave node 1d-k DMA-transfers the distribution data Dj[m, k] generated by the aggregation processing unit 112 in the GPU 11d-k-j to any of the GPU reception buffer 120-1 and the GPU reception buffer 120-2 that is not currently busy in the FPGA 12d-k of the slave node 1d-k (step S800 in FIG. 26).

In a case that data is stored in the both GPU reception buffers 120-1 and 120-2 in the FPGA 12d-k of the slave node 1d-k and any of the network transmission buffers 122 and 123 is empty, the transfer unit 132d in the FPGA 12d-k transfers the data stored in the GPU reception buffers 120-1 and 120-2 to the addition unit 134 (step S8oi in FIG. 26).

The addition unit 134 in the FPGA 12d-k of the slave node 1d-k calculates a sum of the distributed data D1[m, k] and D2[m, k] received from the GPU reception buffers 120-1 and 120-2 per corresponding weight w[m] to generate the intermediate aggregated data Rt[m, k](step S802 in FIG. 26). The addition unit 134 transfers the intermediate aggregated data Rt[m, k] to either the network transmission buffer 122 or 123 having an available space in the FPGA 12d-k (step S803 in FIG. 26).

In a case that data is stored in the network transmission buffer 122 or 123 in the FPGA 12d-1 of the master node 1d-1 and any of the network reception buffers 124 and 125 in the FPGA 12d-1 is empty (YES in step S704 in FIG. 25), the monitoring unit 130d in the FPGA 12d-1 sets a check flag F (step S705 in FIG. 25).

Similarly, in a case that data is stored in the network transmission buffer 122 or 123 in the FPGA 12d-k of the slave node 1d-k and any of the network reception buffers 124 and 125 in the FPGA 12d-k is empty (YES in step S804 in FIG. 26), the monitoring unit 130f in the FPGA 12d-k sets the check flag F (step S805 in FIG. 26).

The monitoring unit 130d in the FPGA 12d-1 of the master node 1d-1 instructs the transmission unit 126 in the FPGA 12d-1 to transmit the data in a case that the check flag F is set in every node 1d-n including the master node 1d-1 itself (YES in step S706 in FIG. 25). The transmission unit 126 in the FPGA 12d-1 retrieves the intermediate aggregated data Rt[m, 1]stored in the network transmission buffer 122 or 123 in the FPGA 12d-1, and transmits the retrieved data as intermediate aggregated data Rz[m, 1] to the next numbered node 1d-2 via the communication path 20 (step S707 in FIG. 25).

Next, the reception unit 127 in the FPGA 12d-i of the node 1d-i (i=2, . . . , N−1) that is an intermediate one of the plurality of slave nodes 1d-k excluding the N-th node receives the intermediate aggregated data Rz[m, i−1] from the node 1d-(i−1) via the communication path 20 (step S806 in FIG. 26).

The addition unit 131d in the FPGA 12d-i of the slave node 1d-i retrieves the intermediated aggregated data Rt[m, i] stored in the network transmission buffer 122 or 123 in the FPGA 12d-i. Then, the addition unit 131d calculates a sum of the retrieved intermediated aggregated data Rt[m, i] and the intermediate aggregated data Rz[m, i−1] received from the communication path 20 per corresponding weight w[m] to generate the intermediate aggregated data Rz[m, i] (step S807 in FIG. 26).

The transmission unit 126 in the FPGA 12d-i of the slave node 1d-i transmits the intermediate aggregated data Rz[m, i] generated by the addition unit 131d in the FPGA 12d-i to the next numbered node 1d-(i+1) via the communication path 20 (step S808 in FIG. 26).

On the other hand, the reception unit 127 in the FPGA 12d-N of the slave node 1d-(N− 1) receives the intermediate aggregated data Rz[m, N−1] from the node 1-(N−1) via the communication path 20 (step S806).

The addition unit 131d in the FPGA 12d-N of the slave node 1d-N retrieves the intermediated aggregated data Rt[m, N] stored in the network transmission buffer 122 or 123 in the FPGA 12d-N. Then, the addition unit 131d calculates a sum of the retrieved intermediated aggregated data Rt[m, N] and the intermediate aggregated data Rz[m, i−1] received from the communication path 20 per corresponding weight w[m] to generate the intermediate aggregated data Rz[m, N] (step S807).

Then, the transmission unit 126 in the FPGA 12d-N of the slave node 1d-N transmits the intermediate aggregated data Rz[m, N] generated by the addition unit 131d in the FPGA 12d-N to the master node 1d-1 via the communication path 20 (step S808).

Next, the reception unit 129 in the FPGA 12d-1 of the master node 1d-1 receives the intermediate aggregated data Rz[m, N] from the node 1d-N via the communication path 20 (step S708 in FIG. 25).

The transmission unit 128 in the FPGA 12d-1 of the master node 1d-1 transmits the received intermediate aggregated data Rz[m, N] as the aggregated data U[m] to the next numbered node 1d-2 (step S709 in FIG. 25).

The reception unit 129 in the FPGA 12d-1 of the master node 1d-1 transfers the aggregated data U[m] (or the intermediate aggregated data Rz[m, N]) received from the node 1d-N via the communication path 20 to either the network reception buffer 124 or 125 having an available space in the FPGA 12d-1 (S710 in FIG. 25).

The transfer unit 133d in the FPGA 12d-1 of the master node 1d-1 retrieves, once any of the network reception buffers 124 and 125 in the FPGA 12d-1 is full, the data from the full network reception buffer to transfer the retrieved data to the GPU transmission buffer 121 in the FPGA 12d-1 (step S711 in FIG. 25).

The transfer unit 132d in the FPGA 12d-1 of the master node 1d-1 DMA-transfers the data stored in the GPU transmission buffer 121 in the FPGA 12d-1 to the GPU 11d-1-1 and the GPU 11d-1-2 (step S712 in FIG. 25).

As described above, the aggregated data U[m] received from the node 1d-N via the communication path 20 is broadcast-transferred to the GPUs 11d-1-1 and 11d-1-2.

On the other hand, the reception unit 129 in the FPGA 12d-k of the slave node 1d-k receives the aggregated data U[m] from the node 1d-(k−1) via the communication path 20 (step S809 in FIG. 26). The transmission unit 128 in the FPGA 12d-k of the slave node 1d-k transmits the received aggregated data U[m] to the next numbered node 1d-k⁺ (k⁺=k+1, where k⁺=1 in a case of k=N) via the communication path 20 (step S810 in FIG. 26).

The reception unit 129 in the FPGA 12d-k of the slave node 1d-k transfers the aggregated data U[m] received from the node 1d-(k−1) via the communication path 20 to either the network reception buffer 124 or 125 having an available space in the FPGA 12d-k (step S811 in FIG. 26).

The transfer unit 133d in the FPGA 12d-K of the slave node 1d-k retrieves, once any of the network reception buffers 124 and 125 in the FPGA 12d-k is full, the data from the full network reception buffer to transfer the retrieved data to the GPU transmission buffer 121 in the FPGA 12d-k (step S812 in FIG. 26).

The transfer unit 132d in the FPGA 12d-k of the slave node 1d-k DMA-transfers the data stored in the GPU transmission buffer 121 in the FPGA 12d-k to the GPU 11d-k-1 and the GPU 11d-k-2 (step S813 in FIG. 26).

As described above, the aggregated data U[m] received from the node 1d-(k−1) via the communication path 20 is broadcast-transferred to the GPUs 11d-k-1 and 11d-k-2.

The weight updating process of the GPU 11d-n-j in each node 1d-n is similar to that in the fourth embodiment.

In the present embodiment, a DMA wait time is reduced in each GPU 11d-n-j of each node 1d-n, and thus, each GPU 11d-n-j can perform other processes by a reduced DMA wait time. In the present embodiment, a band of the GPU-FPGA bus can be effectively used by using the DMA transfer queue. In the present embodiment, a band of the network can be effectively used by increased network transmission buffer. In the present embodiment, the inter-node Allredude process can be performed by one FPGA of each node 1d-n, allowing power saving and space-saving to be achieved. In the present embodiment, the number of network reception buffers and GPU transmission buffers in the FPGA can be reduced compared to the first to fourth embodiments, which makes it possible to reduce a circuit area and reduce costs.

In the present embodiment, the all aggregation processes in the Allredude process which is the slowest process in collective communication are performed in hardware of the FPGA 12d-n, and thus, processing on the GPU side is lightened and a processing latency is also sped up. Each GPU 11d-n-j can select the GPU reception buffer that is not busy, and thus, a GPU reception buffer free wait time can be reduced, allowing the entire processing time to be shortened. In the present embodiment, the plurality of nodes 1d-n are connected via one communication path 20 similarly to the related art, and thus, the number of network ports provided in each node 1d-n can be the same number as in the related art. In the present embodiment, the number of check flags is less than that in the first to fifth embodiments, and thus, it is possible to reduce the wait time until the all check flags are set, and reduce the processing time.

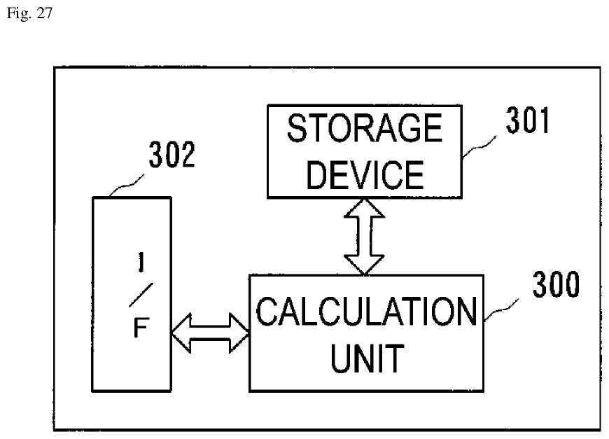

Each of the nodes described in the first to sixth embodiments can be implemented by a computer including a calculation unit such as CPU and a GPU, a storage apparatus, and an interface, programs for controlling these hardware resources, and an FPGA. An exemplary configuration of the computer is illustrated in FIG. 27. The computer includes a calculation unit 300, a storage device 301, and an interface device (I/F) 302. The I/F 302 is connected with a communication circuit, for example. The calculation unit 300 such as a CPU and a GPU in each node performs the processes described in the first to sixth embodiments in accordance with the programs stored in each storage device 301.

### INDUSTRIAL APPLICABILITY

Embodiments of the present invention can be applied to techniques for performing machine learning of a neural network.

### REFERENCE SIGNS LIST

1, 1a to 1d . . . Node
2, 2d . . . Network
10 . . . CPU
11, 11a to 11d . . . GPU
12, 12a to 12d . . . FPGA
13 . . . Model
110 . . . Sample input unit
111 . . . Gradient calculation processing unit
112, 118 . . . Aggregation processing unit
113 . . . Weight updating processing unit
114, 114a, 114b, 116, 126, 128 . . . Transmission unit
115, 117, 127, 129 . . . Reception unit
120 . . . GPU reception buffer
121 . . . GPU transmission buffer
122, 123 . . . Network transmission buffer
124, 125 . . . Network reception buffer
130, 130b, 130d . . . Monitoring unit
131, 131a, 131b, 131d, 134 . . . Addition unit
132, 132a to 132d, 133, 133c, 133d . . . Transfer unit.

1-7. (canceled)

8. A distributed deep learning system comprising:
a plurality of nodes connected with each other via a network, wherein each node of the plurality of nodes includes:
a plurality of GPUs configured to generate distributed data per weight of a model to be learned;
a plurality of first reception buffers configured to store the distributed data from the plurality of GPUs, wherein the plurality of GPUs is configured to DMA-transfer the distributed data to the plurality of first reception buffers;
a plurality of first transmission buffers configured to store the distributed data transferred from the plurality of first reception buffers;
a plurality of second reception buffers configured to store aggregated data received from another node of the plurality of nodes;
a second transmission buffer configured to store the aggregated data transferred from the plurality of second reception buffers;
a monitoring circuit configured to set a check flag when data is stored in any of the plurality of first transmission buffers and any of the plurality of second reception buffers has available space;
a first transmission circuit configured to transmit, when the check flag is set in the node itself and every other node of the plurality of nodes in a case that the node functions as a first numbered node among the plurality of nodes, the distributed data stored in the plurality of first transmission buffers as first aggregated data to a next numbered node of the plurality of nodes, and transmit, in a case that the node functions as a node except for the first numbered node among the plurality of nodes, updated first aggregated data to the next numbered node;
a first reception circuit configured to receive, in the case that the node functions as the node except for the first numbered node among the plurality of nodes, the first aggregated data from another node of the plurality of nodes;
an addition circuit configured to calculate, in the case that the node functions as the node except for the first numbered node among the plurality of nodes, a sum of the distributed data stored in the first transmission buffer and the first aggregated data received by the first reception circuit per weight to generate the updated first aggregated data;
a second reception circuit configured to receive the updated first aggregated data in the case that the node functions as the first numbered node among the plurality of nodes, and receives second aggregated data in the case that the node functions as the node except for the first numbered node among the plurality of nodes;
a second transmission circuit configured to transmit, in the case that the node functions as the first numbered node among the plurality of nodes, the first aggregated data received by the second reception circuit as the second aggregated data to the next numbered node, and transmit, in the case that the node functions as the node except for the first numbered node among the plurality of nodes, the second aggregated data received by the second reception circuit to the next numbered node;
a first transfer circuit configured to transfer the distributed data stored in the plurality of first reception buffers to the plurality of first transmission buffers, and DMA-transfer the aggregated data stored in the second transmission buffer to the plurality of GPUs; and
a second transfer circuit configured to transfer the aggregated data stored in the plurality of second reception buffers to the second transmission buffer.

9. The distributed deep learning system according to claim 8, wherein:
a plurality of communication paths are configured in the network;
for each node of the plurality of nodes:
a quantity of the plurality of first reception buffers equals a quantity of the plurality of communication paths;
the plurality of first transmission buffers are provided per one communication path;
the plurality of second reception buffers are provided per one communication path;
a quantity of the plurality of second transmission buffers equals the quantity of the plurality of communication paths;
each of the plurality of GPUs includes:
a third transmission circuit configured to DMA-transfer the distributed data to respective ones of the plurality of first reception buffers;
a third reception circuit configured to receive the second aggregated data DMA-transferred by the first transfer circuit;
a fourth transmission circuit configured to transmit the second aggregated data received by the third reception circuit to another GPU of the plurality of GPUs;
a fourth reception circuit configured to receive the second aggregated data transmitted from another GPU of the plurality of GPUs;
an aggregation processing circuit configured to calculate a sum of the second aggregated data received by the third reception circuit and the second aggregated data received by the fourth reception circuit per weight to generated third aggregated data; and
an updating circuit configured to update the model in accordance with the third aggregated data;
the first transfer circuit is configured to transfer the distributed data stored in a first reception buffer of plurality of first reception buffers corresponding to a first communication path to a first transmission buffer of the plurality of first transmission buffers corresponding to the first communication path, and DMA-transfer the second aggregated data stored in a second transmission buffer of the plurality of second transmission buffers corresponding to a second communication path to a GPU of the plurality of GPUs corresponding to the second communication path;
the second transfer circuit is configured to transfer the second aggregated data stored in the second reception buffer corresponding to the second communication path to the second transmission buffer corresponding to the second communication path;
when the data is stored in the first transmission buffer and the second reception buffer has available space, the first communication path being identical to the second communication path, the monitoring circuit is configured to set the check flag corresponding to the first communication path;
in the case that the node functions as the first numbered node among the plurality of nodes when the check flag corresponding to the first communication path is set in the node itself and every other node, and the check flag corresponding to another communication path is not set in at least one node, the first transmission circuit is configured to transmit the distributed data stored in the first transmission buffer corresponding to the first communication path as the first aggregated data to the next numbered node via the first communication path; and
the addition circuit is configured to calculate a sum of the distributed data stored in the first transmission buffer corresponding to the first communication path and the first aggregated data received from the first communication path by the first reception circuit per weight to generate the updated first aggregated data.

10. The distributed deep learning system according to claim 8, wherein:
a plurality of communication paths are configured in the network,
for each node of the plurality of nodes:
a quantity of the plurality of first reception buffers equals a quantity of the plurality of communication paths;
the plurality of first transmission buffers provided per one communication path;
the plurality of second reception buffers provided per one communication path;
a quantity of the plurality of second transmission buffers equals the quantity of the plurality of communication paths;
each of the plurality of GPUs includes:
a third transmission circuit configured to DMA-transfer the distributed data to respective ones of the plurality of first reception buffers;
a third reception circuit configured to receive the second aggregated data DMA-transferred by the first transfer circuit;
a fourth transmission circuit configured to transmit the second aggregated data received by the third reception circuit to another GPU of the plurality of GPUs;
a fourth reception circuit configured to receive the second aggregated data transmitted from another GPU of the plurality of GPUs;
an aggregation processing circuit configured to calculate a sum of the second aggregated data received by the third reception circuit and the second aggregated data received by the fourth reception circuit per weight to generated third aggregated data; and
an updating circuit configured to update the model in accordance with the third aggregated data;
the first transfer circuit is configured to transfer the distributed data stored in a first reception buffer of plurality of first reception buffers corresponding to a first communication path to a first transmission buffer of the plurality of first transmission buffers corresponding to the first communication path, and DMA-transfer the second aggregated data stored in a second transmission buffer of the plurality of second transmission buffers corresponding to a second communication path to a GPU of the plurality of GPUs corresponding to the second aggregated data;
the second transfer circuit is configured to transfer the second aggregated data stored in the second reception buffer corresponding to the second communication path to the second transmission buffer corresponding to the second communication path;
when the data is stored in the first transmission buffer and the second reception buffer has available space, the first communication path being identical to the second communication path, the monitoring circuit is configured to set the check flag corresponding to the first communication path;
in a case that the node functions as the first numbered node among the plurality of nodes when the check flag corresponding to the first communication path is set in the node itself and every other node, and the check flag corresponding to another communication path is not set in at least one node, the first transmission circuit is configured to transmit the distributed data stored in the first transmission buffer corresponding to the first communication path as the first aggregated data to the next numbered node via the first communication path; and
in a case that the GPU deriving the first aggregated data received from another node by the first reception circuit is in the same combination with the GPU generating the distributed data and the distributed data is stored in the first transmission buffer, the addition circuit is configured to calculate a sum of the distributed data and the first aggregated data received by the first reception circuit per weight to generate the updated first aggregated data.

11. The distributed deep learning system according to claim 8, wherein:
a plurality of communication paths are configured in the network;
for each node of the plurality of nodes:
a quantity of the plurality of first reception buffers equals a quantity of the plurality of communication paths;
the plurality of first transmission buffers are provided per one communication path;
the plurality of second reception buffers are provided per one communication path;
a quantity of the plurality of second transmission buffers equals the quantity of the plurality of communication paths;
each of the plurality of GPUs includes:
a third transmission circuit configured to DMA-transfer the distributed data an available first reception buffer that is not busy among the plurality of reception buffers;
a third reception circuit configured to receive the second aggregated data DMA-transferred by the first transfer circuit, and
an updating circuit configured to update the model in accordance with the second aggregated data received by the third reception circuit,
the first transfer circuit is configured to transfer the distributed data stored in a first reception buffer of plurality of first reception buffers corresponding to a first communication path to a first transmission buffer of the plurality of first transmission buffers corresponding to the first communication path, and DMA-transfer the second aggregated data stored in a second transmission buffer of the plurality of second transmission buffers corresponding to a second communication path to a GPU of the plurality of GPUs corresponding to the second communication path;
the second transfer circuit is configured to transfer the second aggregated data stored in the second reception buffer corresponding to the second communication path to the second transmission buffer corresponding to the second communication path;
when the data is stored in the first transmission buffer and the second reception buffer has available space, the first communication path being identical to the second communication path, the monitoring circuit is configured to set the check flag corresponding to the first communication path;
in the case that the node functions as the first numbered node among the plurality of nodes when all check flags are set in the node itself and every other node, the first transmission circuit is configured to transmit the distributed data stored in the plurality of first transmission buffers as the first aggregated data to the next numbered node via the communication paths corresponding to the first transmission buffers storing the distributed data; and
the addition circuit is configured to calculate a sum of the distributed data stored in the plurality of first transmission buffers corresponding to the plurality of communication paths and the first aggregated data received from the plurality of communication paths by the first reception circuit per weight to generate the updated first aggregated data.

12. The distributed deep learning system according to claim 8, wherein:
a plurality of communication paths are configured in the network,
for each node of the plurality of nodes:
a quantity of the plurality of first reception buffers equals a quantity of the plurality of communication paths;
the plurality of first transmission buffers are provided per one communication path,
the plurality of second reception buffers are provided common to the plurality of communication paths;
the second transmission buffer are provided common to the plurality of communication paths;
each of the GPUs includes:
a third transmission unit configured to DMA-transfer the distributed data to the first reception buffer not busy among the plurality of reception buffers;
a third reception circuit configured to receive the second aggregated data DMA-transferred by the first transfer circuit; and
an updating circuit configured to update the model in accordance with the second aggregated data received by the third reception circuit;
the first transfer circuit is configured to transfer the distributed data stored in a first reception buffer of plurality of first reception buffers corresponding to a first communication path to a first transmission buffer of the plurality of first transmission buffers corresponding to the first communication path, and DMA-transfer the second aggregated data stored in a second transmission buffer of the plurality of second transmission buffers corresponding to a second communication path to the plurality of GPUs;
the second transfer circuit is configured to transfer the second aggregated data stored in the plurality of second reception buffers to the second transmission buffer;
when the data is stored in the first transmission buffer and the second reception buffer has available space, the first communication path being identical to the second communication path, the monitoring circuit is configured to set the check flag corresponding to the first communication path;
in the case that the node functions as the first numbered node among the plurality of nodes when all check flags are set in the node itself and every other node, the first transmission circuit is configured to transmit the distributed data stored in the plurality of first transmission buffers as the first aggregated data to the next numbered node via the communication paths corresponding to the first transmission buffers storing the distributed data; and
the addition circuit is configured to calculate a sum of the distributed data stored in the plurality of first transmission buffers corresponding to the plurality of communication paths and the first aggregated data received from the plurality of communication paths by the first reception circuit per weight to generate the updated first aggregated data.

13. A distributed deep learning system comprising:
plurality of nodes connected with each other via a network, wherein each node of the plurality of nodes includes:
a plurality of GPUs configured to generate distributed data per weight of a model to be learned;
a plurality of first reception buffers configured to store the distributed data from the plurality of GPUs, wherein the plurality of GPUs is configured to DMA-transfer the distributed data to the plurality of first reception buffers;
a first addition circuit configured to calculate a sum of a plurality of pieces of the distributed data transferred from the plurality of first reception buffers per weight to generate first aggregated data;
a plurality of first transmission buffers configured to store the first aggregated data;
a plurality of second reception buffers configured to store aggregated data received from another node of the plurality of nodes;
a second transmission buffer configured to store the aggregated data transferred from the plurality of second reception buffers;
a monitoring circuit configured to set a check flag when data is stored in the first transmission buffers and the second reception buffers has available space;
a first transmission circuit configured to transmit, when the check flag is set in the node itself and every other node in a case that the node functions as a first numbered node among the plurality of nodes, the first aggregated data stored in any of the first transmission buffers as second aggregated data to the next numbered node, and transmit, in a case that the node functions as a node except for the first numbered node among the plurality of nodes, updated second aggregated data to the next numbered node;
a first reception circuit configured to receive, in the case that the node functions as the node except for the first numbered node among the plurality of nodes, the second aggregated data from another node;
a second addition circuit configured to calculate, in the case that the node functions as the node except for the first numbered node among the plurality of nodes, a sum of the first aggregated data stored in the first transmission buffer and the second aggregated data received by the first reception circuit per weight to generate the updated first aggregated data;
a second reception circuit configured to receive the updated second aggregated data in the case that the node functions as the first numbered node among the plurality of nodes, and receives third aggregated data in the case that the node functions as the node except for the first numbered node among the plurality of nodes;
a second transmission circuit configured to transmit, in the case that the node functions as the first numbered node among the plurality of nodes, the second aggregated data received by the second reception circuit as the third aggregated data to the next numbered node, and transmit, in the case that the node functions as the node except for the first numbered node among the plurality of nodes, the third aggregated data received by the second reception circuit to the next numbered node;
a first transfer circuit configured to transfer the distributed data stored in the first reception buffers to the first addition circuit, and DMA-transfer the third aggregated data stored in the second transmission buffer to the plurality of GPUs; and
a second transfer circuit configured to transfer the third aggregated data stored in the second reception buffers to the second transmission buffer, wherein the plurality of GPUs is configured to update the model in accordance with the third aggregated data.

14. The distributed deep learning system according to claim 13, wherein:
a communication path is configured in the network,
for each node of the plurality of nodes:
a quantity of the first reception buffers equals a quantity of the plurality of GPUs;
a quantity of the second transmission buffers equals a quantity of the communication paths in the network,
each of the plurality of GPUs includes:
a third transmission circuit configured to DMA-transfer the distributed data to a first reception buffer that is available among the plurality of reception buffers;
a third reception circuit configured to receive the third aggregated data DMA-transferred by the first transfer circuit; and
an updating circuit configured to update the model in accordance with the third aggregated data received by the third reception circuit;
the second transfer circuit is configured to transfer the third aggregated data stored in the plurality of second reception buffers to the second transmission buffer,
when the data is stored in the first transmission buffer and the second reception buffer has an available space, the first transmission buffer and the second reception buffer corresponding to the identical communication path, the monitoring circuit is configured to set the check flag corresponding to the communication path; and
the second addition circuit is configured to calculate a sum of the first aggregated data stored in any of the plurality of first transmission buffers and the second aggregated data received from the communication path by the first reception circuit per weight to generate the updated second aggregated data.
